(19) United States
(12) Patent Application Publication
(10) Pub. No.: US 2006/0023461 A1
(43) Pub. Date: Feb. 2, 2006

(54) Vehicular dynamic angle adjusted lighting

(76) Inventor: Richard Knight, Bournemouth (GB)

Correspondence Address: FORTKORT GRETHER + KELTON LLP, 9442 N. Capital of Texas Hwy., Suite 500, AUSTIN, TX, 78759, US

(21) Appl. No.: 11/240,096

(22) Filed: Sep. 30, 2005

Related U.S. Application Data
(63) Continuation-in-part of application No. 11/121,595, filed on May 3, 2005.
Application No. 11/121,595 is a continuation of application No. 10/043,214, filed on Jan. 14, 2002.

(51) Int. Cl. B60Q 1/08

(52) U.S. Cl. 362/466; 362/525; 362/545; 362/43; 362/250

(57) ABSTRACT

A vehicular dynamic angle adjustment lighting device for vehicles that can vary the beam angle and direction of a light beam to adjust for driving circumstances and conditions is described. In some embodiments many of the adjustments to driving circumstances and conditions are implemented automatically without direct input by the driver.

### RELATED APPLICATION

This application is a continuation-in-part application of U.S. patent application Ser. No. 11/121,595 filed on May 3, 2005 which is a continuation application of U.S. patent application Ser. No. 10/043,214, filed Jan. 14, 2002, now allowed.

### TECHNICAL FIELD OF INVENTION

This invention relates to automotive lighting and signaling. More particularly the invention relates to adaptive lighting and signaling systems for vehicles.

### BACKGROUND OF THE INVENTION

According to one aspect of the present invention there is provided an angle adjustment device comprising a support member, a plurality of holders for light emitting or receiving devices, each holder being supported by the support member for pivotable movement about at least one axis, and an elongate spiral element which cooperates with the holders so that when the spiral element is displaced angularly about its axis relative to the support member, each holder pivots about its said at least one axis.

Preferably, said at least one axis of each holder extends perpendicularly or substantially perpendicularly to a radius extending outwardly from the axis of the spiral and through the holder.

Preferably, the spiral element passes through an aperture in each holder or in a part connected to each holder and is slidable relative to each holder when displaced angularly.

Preferably, means (typically an electric motor) is provided for angularly displacing the spiral element about its axis.

Preferably, the holders are spaced apart on the support member along a spiral path. Alternatively, the holders may be spaced apart on the support member in concentric circles.

Advantageously, each holder is connected to the support member by a universal joint. In this case, one or more angularly displaceable members may be connected to the holders so that when the angularly displaceable member(s) is/are displaced angularly relative to the support member, each holder pivots about a second axis extending perpendicularly or substantially perpendicularly to said one axis. The angularly displaceable member(s) is/are typically in form of a further spiral or a plurality of spokes extending radially outwards from the axis of the first mentioned spiral. Means (typically a second electric motor) may be provided for angularly displacing the angularly displaceable member(s) relative to the support member.

The angle adjustment device may also comprise a plurality of light emitting devices supported by the holders. The light emitting devices are preferably in the form of light emitting diodes (LED's) and typically in for form of white LED's each having red, blue and green guns, but they could be in the form of fibre optics.

The support member may be capable of flexing and means (typically a third electric motor) may be provided for flexing the support member between a planar condition and a bowl-shaped and/or dome-shaped condition.

According to a further aspect of the invention there is provided automated lighting having a source of light formed by a plurality of white light emitting diodes.

The invention will now be more particularly described, by way of example, with reference to the accompanying drawings.

### BRIEF DESCRIPTION OF THE DRAWINGS

For a more complete understanding of the present invention and advantages thereof, reference is made to the following description taken in conjunction with the accompanying drawings in which like reference numbers indicate like features and where:

FIG. 1 is a plan view of one embodiment of an angle adjustment device according to the invention;

FIG. 2 is a fragmentary plan view of part of the angle adjustment device of FIG. 1 on an enlarged scale;

FIG. 3 is a section taken along the line X-X of FIG. 2 on a much enlarged scale;

FIG. 4 is a view generally at right angles to the view of FIG. 3;

FIG. 5 is a side view showing the manner in which a holder is deflected about a radially outwardly extending axis;

FIG. 6 is a plan view similar to FIG. 2 but showing the holders deflected about the radially extending axis;

FIG. 7 is a side view showing the holders deflected about an axis perpendicular to the radially extending axis;

FIG. 8 is a plan view similar to FIG. 2 but showing the holders deflected about the axis perpendicular to the radially extending axis;

FIG. 9 is a view similar to FIG. 3 of another embodiment of an angle adjustment device according to the invention;

FIG. 10 is a top view illustration of a vehicle with adaptive headlights with narrow beam angle in a horizontal direction;

FIG. 11 is a top view illustration of a vehicle with adaptive headlights with wide beam angle in a horizontal direction;

FIG. 12 is a top view illustration of a vehicle with adaptive headlights at a narrower beam angle with the direction of the beam shifted to the right—the direction toward which the vehicle is turning in the illustration;

FIG. 13 is a top view illustration of a vehicle with adaptive headlights at a wider beam angle with the direction of the beam shifted to the left—the direction toward which the vehicle is turning in the illustration;

FIG. 14 is a top view illustration of a vehicle reversing and showing adaptive rear lights directed to the left;

FIG. 15 is a side view illustration of a vehicle with adaptive headlights with the headlights directed further in the distance;

FIG. 16 is a side view illustration of a vehicle with adaptive headlights with wider beam angle directed down closer to the front of the vehicle than the beam illustrated in FIG. 15.

FIG. 17 is an top view illustration of the sensor inputs to the Central Processing Unit and the outputs from the CPU to the Headlamps and rear lights;

FIG. 18 is a front view illustration of an embodiment of one of the adaptive headlights;

FIG. 19 is a side view illustration of elements of the adaptive headlight illustrated in FIG. 18 configured to generate a narrow beam angle in the horizontal axis;

FIG. 20 is a side view illustration of the elements of the adaptive headlight illustrated in FIG. 19 configured to generate a wide beam angle in the horizontal axis;

FIG. 21 is an illustration of the elements of the adaptive headlight illustrated in FIG. 19 with a change in the direction of the light beam in the horizontal axis as illustrated in FIG. 12 showing a narrow steered beam;

FIG. 22 is an illustration of the elements of the adaptive headlight illustrated in FIG. 19 with a change in direction of the light beam in the horizontal axis at a wide beam angle as illustrated in FIG. 13;

FIG. 23 is an illustration of a steerable light elements and the steering gears of an adaptive headlight;

FIG. 24 is an illustration of one embodiment of the steerable light elements in the adaptive headlights;

FIG. 25 & FIG. 26 illustrate the steering gears that determine the angular position of the steerable light elements in the adaptive headlights thus determining the beam angle of the adaptive headlight;

FIG. 27 illustrates the steering gears in a position to create a narrow beam angle;

FIG. 28 illustrates the steering gears in a position to create a wide beam angle;

FIG. 29 & FIG. 30 illustrate alternative embodiments of steering gears that allow for greater airflow;

FIG. 31 illustrates the positions of the gears for a light element array of FIG. 18 that drive the direction of the light beam in a configuration where the lights are pointed straight ahead and the light beam is in a narrow beam angle configuration;

FIG. 32 illustrates the positions of the gears that drive the direction of the light beam in a configuration where the lights are pointed straight ahead and the light beam is in a wide beam angle configuration;

FIG. 33 illustrates the position of the gears that drive the direction of the light beam in a configuration where the lights are pointed to the right and the light beam is in a narrow beam angle configuration;

FIG. 34 illustrates the position of the gears that drive the direction of the light beam in a configuration where the lights are pointed up and the light beam is in a wide beam angle configuration;

FIG. 35 illustrates an alternative embodiment of a larger array of steerable light elements;

FIG. 36 illustrates one of the beam angle adjustment steering gears for the element array of FIG. 35;

FIG. 37 illustrates the complementary beam angle adjustment gear illustrated in FIG. 36 together with a complementary beam angle adjustment gear in a configuration to generate a narrow beam angle composite light beam;

FIG. 38 illustrates the complementary beam angle adjustment gears illustrated in FIG. 37 in a configuration to generate a wide beam angle composite light beam;

FIG. 39 illustrates a side view of the light elements of the array illustrated in FIG. 35 when the complementary beam angle adjustment gears illustrated in FIG. 38 are configured to generate a wide beam angle composite light beam;

FIG. 40 illustrates one method of directing the steering gears in unison;

FIG. 41 illustrates a front view of an alternative embodiment of a light element array of steerable light elements;

FIG. 42 illustrates a side view of the array illustrated in FIG. 41;

FIG. 43 & FIG. 44 illustrate complementary beam angle adjustment gears for the array illustrated in FIG. 41;

FIG. 45 illustrates the complementary beam angle adjustment gears illustrated in FIG. 43 and FIG. 44, with the light element array shown in FIG. 41, in a configuration where the composite light beam generated by the light elements is a narrow angle beam;

FIG. 46 illustrates the complementary beam angle adjustment gears illustrated in FIG. 43 and FIG. 44, with the light element array shown in FIG. 41, in a configuration where the composite light beam generated by the light elements is a wide angle beam in the x axis (left to right on the page—the y axis being up and down the page);

FIG. 47 is a illustration of the light element array where the beam angle adjustment gears are configured to generate a wide beam angle composite light beam with the light beam steered to the right;

FIG. 48 show a side view of FIG. 47 with the light beam that is wide in the x axis and steered to the right;

FIGS. 49 and 50 illustrate an alternative embodiment of complementary beam angle adjustment gears for the light element array illustrated in FIG. 41;

FIG. 51 illustrates the beam angle adjustment gears illustrated in FIGS. 49 and 50 in a configuration to generate a wide composite light beam in the y axis;

FIG. 52 illustrates the beam angle adjustment gears illustrated in FIGS. 49 and 50 in a configuration to generate a wide beam angle composite light beam in both the x axis and y axis;

FIG. 53 illustrates an embodiment of the adaptive headlights where a portion of the skin or outer chassis of the vehicle serves the support function of the base plate; and

FIG. 54 illustrates the headlamp illustrants the adaptive headlamp section of the chassis in greater detail.

### DETAILED DESCRIPTION OF THE FIGURES

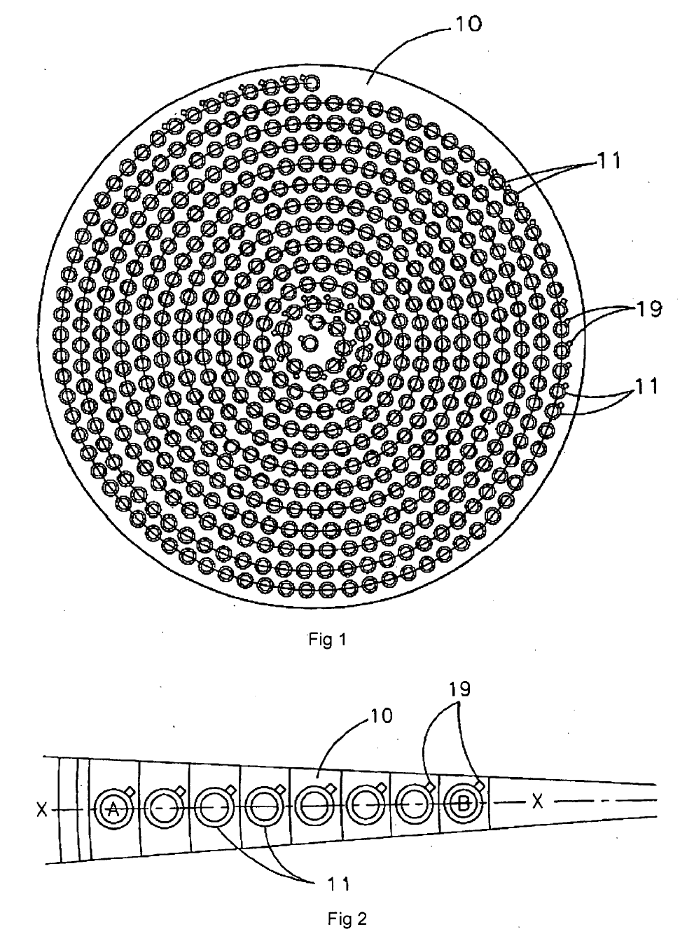

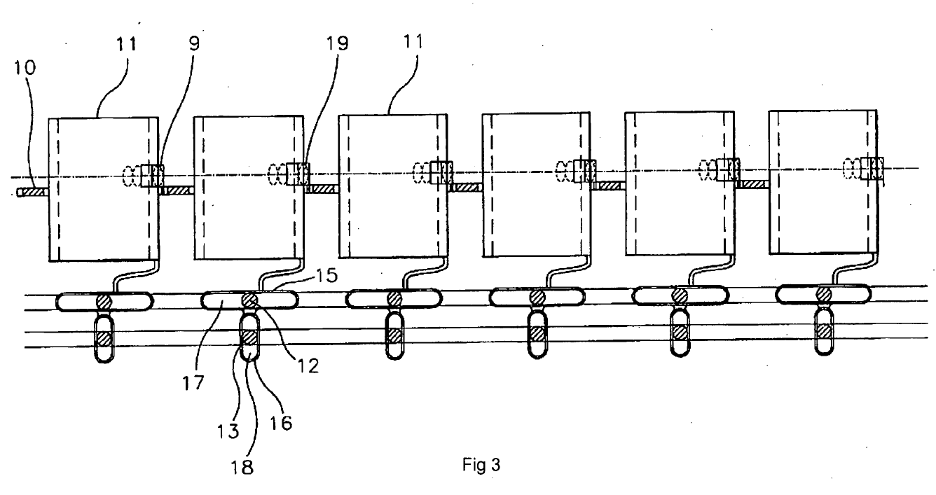

The preferred embodiment of the present invention and its advantages are best understood by referring to FIG. 1 through FIG. 54 of the drawings, like numerals being used for like and/or corresponding parts of the various drawings.

Referring firstly to FIG. 1 to FIG. 8 of the drawings, the angle adjustment device shown therein comprises a support member 10, a plurality of LED holders 11 supported by the support member 10 and two spiral elements 12 and 13.

The support member 10 is in the form of a tightly wound spiral which is punched out of sheet material, typically plastics material or an aluminium alloy, and which is capable of flexing for a purpose which will become apparent hereinafter. The support member 10 is mounted in a retaining bowl 14 and has its outer peripheral edge secured to the lip of the bowl 14.

The LED holders 11 are connected to the support member 10 by universal joints 19 so that the holders 11 can pivot relative to the support member 10.

Each holder 11 has two eyelets 15 and 16. The eyelet 15 has an elongate horizontally extending slot 17 and the eyelet 16 has an elongate vertically extending slot 18.

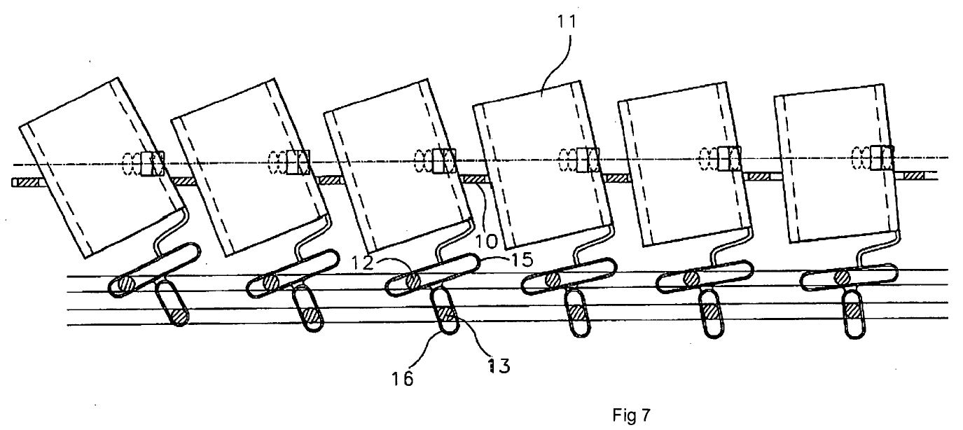

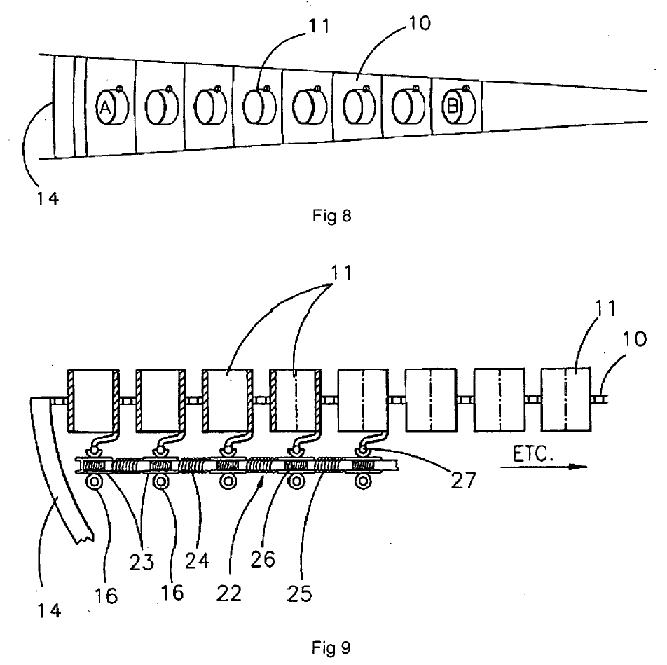

The first and second elongate spiral elements 12 and 13, typically formed from relatively rigid wire, are wound through the eyelets 15 and 16, respectively. The spiral element 13 is not attached to the eyelets 16 but is slidable relative thereto and is rotatable relative to the support member 10 by an electric motor (not shown). Rotation of the spiral element 13 will move the eyelets 16 radially inwards or radially outwards depending on the direction of rotation of the spiral element 13 and this will cause the holders 11 to tilt as shown in FIG. 7 and FIG. 8. If the spacing between all turns of the spiral is equal and if the outer end of the spiral element 13 is free and allowed to wind into and out of a guide slot located around the inside of the bowl 14, all holders 11 will be deflected by equal amounts. If the outer end of the spiral element 13 is clamped or driven by a motor at a different speed from the inner end, rotation of the spiral element 13 at the centre will cause unequal deflection of the inner and outer holders 11. Assuming a clockwise wound spiral element 13, clamping the outer edge of the spiral whilst the centre of the spiral element is rotated in an anti-clockwise direction will result in an increase in the spacing between the outer turns of the spiral element 13 and a tightening of the inner coils. The outer holders will then deflect more than the inner holders. If the spiral element 13 is wound so that the spacing between turns increases as it winds outwards, the outer holders will deflect more than the inner holders. Conversely, if the spiral element 13 is wound so that the spacing between turns decreases as it winds outwards, the inner holders will deflect more than the outer holders.

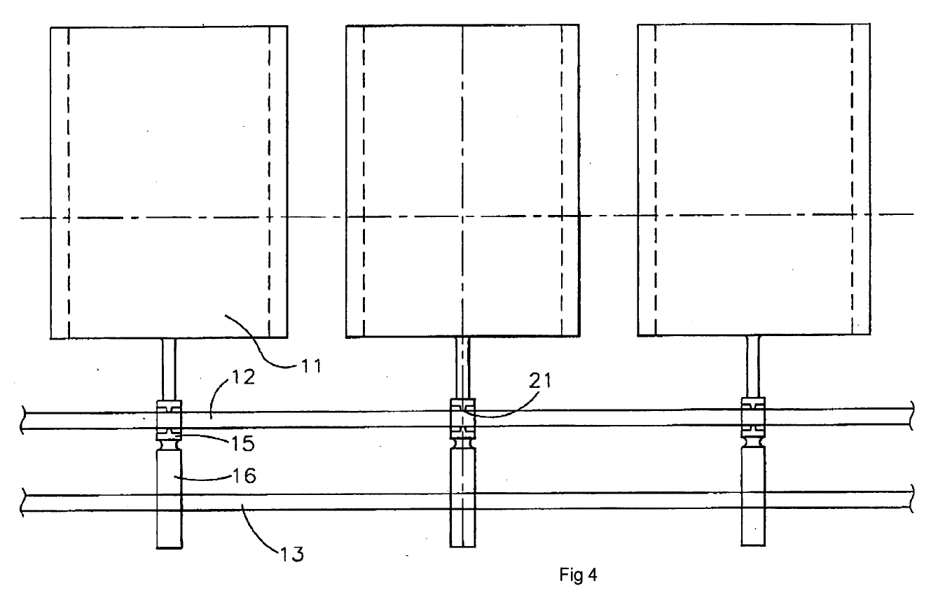

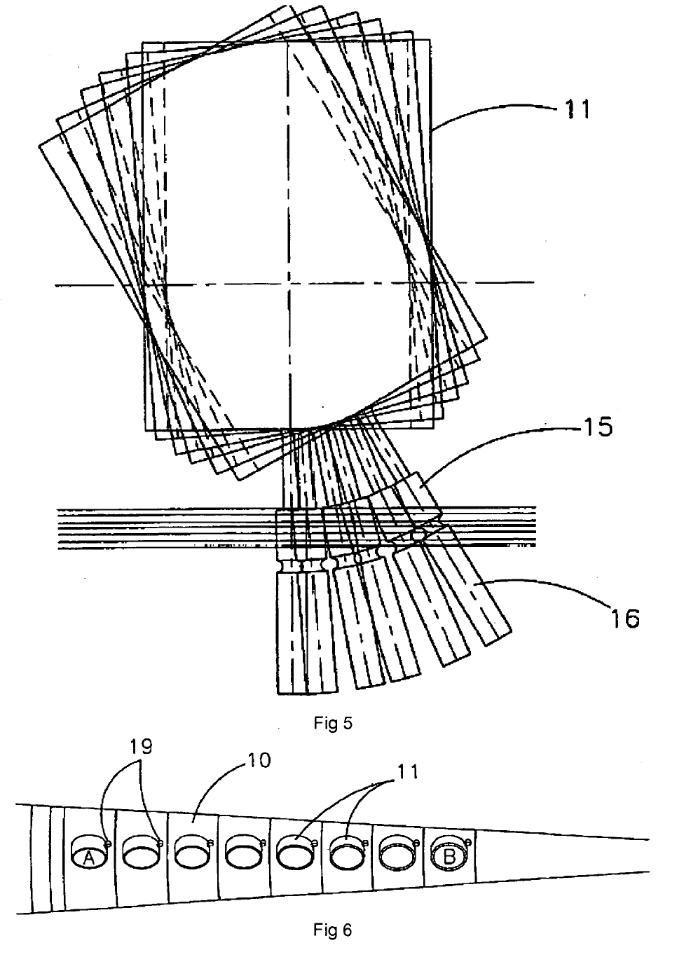

The spiral element 12 is held captive with respect to the eyelets 15 of each holder 11 so that the spiral element 19 can slide along the slot 17 but cannot slide relative to the eyelet in the direction of the longitudinal extent of the spiral. This can be done as shown in FIG. 4 by providing indents 21 in the spiral element 12 in which the eyelet 15 engages or by collars or washers (not shown) fixed to the spiral element 12 on opposite sides of the eyelet 15. The spiral element 12 is angularly displaceable relative to the support member 10 by a second electric motor (not shown). Such angular movement of the spiral element 19 will cause the holders 11 to tilt about a radially extending axis as shown in FIG. 5 and FIG. 6.

The spiral elements 12 and 13 can be displaced by their respective motors at the same time.

The eyelets 15 and 16 (and the spiral elements 19 and 20) could be interchanged so that the top spiral element causes deflection about an axis at right angles to a radius and the bottom spiral element produces deflection about a radially extending axis.

A third electric motor (not shown) could he provided to push the support member 10, together with the spiral elements 12 and 13, from the planar condition shown in the drawings into a dome-shamed condition or to pull the support member 10, together with the spiral elements 12 and 13, into a bowl-shaped condition. It is for this reason that the support member 10 is formed so as to be capable of flexing.

In a preferred embodiment the holders 11 support white LED's each having blue red and green guns. They could however support fibre optics or lenses or light sensitive devices.

Referring now to FIG. 9 of the drawings, the spiral element 12 is replaced by spokes 22. The spokes 22 are telescopically extendible and are located below the support member 10. The spokes 22 extend radially outwards from the axis of the spiral support member 10 and are equi-angularly spaced. Each spoke 22 comprises a plurality of sleeve-like parts 23 and a plurality of rod-like parts 24 each of which is slidably mounted in two adjacent sleeve-like parts 23 thus permitting the spokes 22 to extend and retract. The sleeve-like parts 23 are interconnected by springs 25 and the rod-like parts 24 are interconnected by springs 26.

Each holder 11 may be connected to one of the sleeve-like parts 23 by a further universal joint 27.

The spokes 22 are angularly displaceable relative to the support member 10 by an electric motor (not shown). Such angular movement of the spokes 22 will cause the holders 11 to tilt about a radially extending axis as shown in FIG. 5 and FIG. 6. The holders 11 closer to the outer periphery of the support member 10 will tilt more than the holders 11 closer to the inner periphery of the support member 10 and this will change the angle and shape of the light beam emitted by LED's supported in the holders 11. The motors can be operated in accordance with a computer program so that the angle adjustment device varies the lighting as required.

The angle adjustment devices described above are particularly suitable for use in automated lighting although they could have other applications.

The embodiments described above are given by way of example and various modifications will be apparent to a person skilled in the art without departing from the scope of the invention. For example, the spokes 22 or second spiral element 12 could be omitted. In this case, the holders 11 could not be tilted as shown in FIG. 5 and FIG. 6 but could still be tilted as shown in FIG. 7 and FIG. 8. Also, the support member 10 may not be capable of flexing and may instead be of fixed planar shape or of fixed dome-like or bowl-like shape.

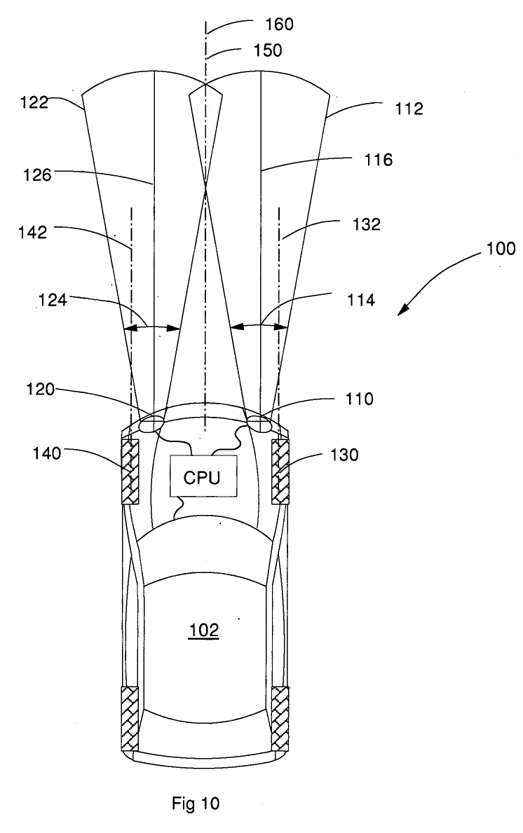

Turning now to FIG. 10 through FIG. 52 an adaptive lighting system for vehicles is illustrated. FIG. 10 illustrates one configuration with the adaptive lighting system 100 applied as motor vehicle 102, with headlamps 110 & 120. The headlamps 110 & 120 generate composite light beams 112 & 122 with adjustable beam angles 114 & 124 and beam directions as indicated by the center axis 116 & 126 of the composite light beams 112 & 122. The vehicle illustrated has steered wheels 130 and 140 the directional axis 132 and 142 of which determine the direction of travel 150 of the vehicle 102 which in this illustration, view from the top, appears to be parallel to the center axis/plane 160 of the vehicle 102.

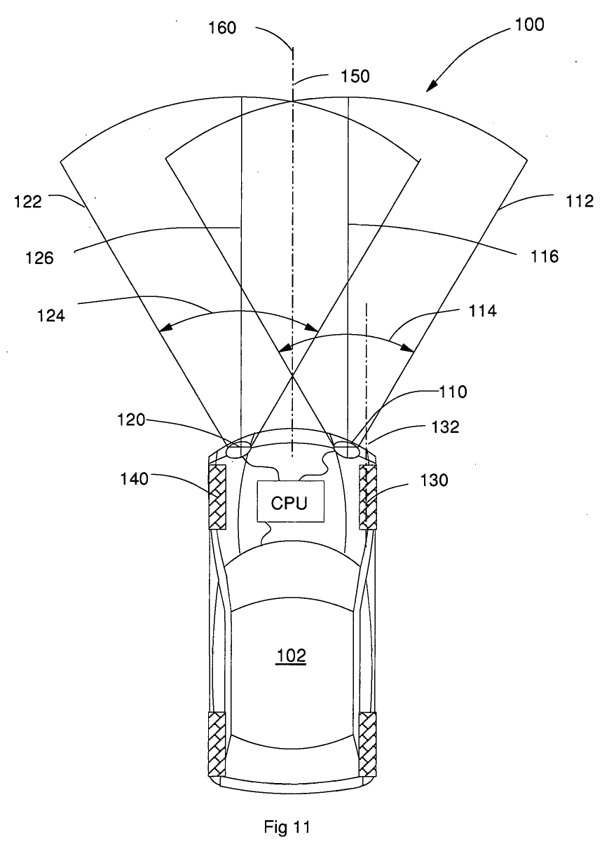

FIG. 11 illustrates the adaptive lighting system 100 for vehicles 102 where the headlamps 110 and 120 are configured to generate composite light beams 112 and 122 with a wide beam angle 114 and 124. The steering wheels 130 and 140 remain pointed straight ahead as indicated by directional axis 132 for wheel 130. The directions 116 and 126 of the light beam in this configuration continue to appear from the top view to be parallel to the center axis/plane 160 of the vehicle 102 and the direction of travel 150. The narrow headlight beams in FIG. 10 would be more conducive to a higher rate of travel while the wider mean angles in FIG. 11 are more conducive to a lower rate of travel. In the embodiments shown in FIG. 10 and FIG. 11 the width of the beam angles 114 and 124 is coordinated. In other embodiments the beam angle of each headlight 110 and 120 can be changed independently.

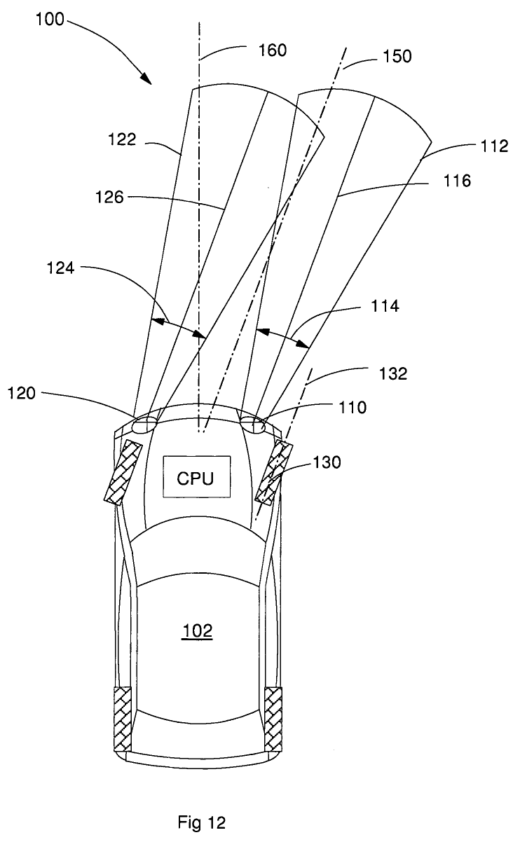

FIG. 12 illustrates another functionality of the adaptive lighting system 100. In this figure the steering of the direction 116 and 126 of the light beams 112 and 122 generated by the headlights 110 and 120 is illustrated. The adaptive headlights in this embodiment are capable of changing the directions of the center of the light beams 116 and 126 relative to the centerline 160 of the vehicle 102. In this illustration the headlight directions 116 and 126 are to the right of the centerline 160 of the vehicle 102. In the illustration the direction of 116, 126 of the light beams is designed to proximate the direction of the movement 150 of the vehicle as determined by the direction 132 of the front steered wheel(s) 130 of the vehicle 102. In other embodiments, the direction of the light beams 116 and 126 may lead the direction of movement 150 of the vehicle—a greater angle of deviation from the centerline 160 of the vehicle. In other embodiments only one of the light beams may change direction as a result of a change in direction of the steered wheels 130. In one embodiment only the headlight on the side of the direction into which the vehicle is turning has its direction modified. In other embodiments both light beams are adjusted but not to the same extent. In other words, the movement of the direction 116 and 126 of the light beams may be coordinated or independent. In this illustration the beam angles 114 and 124 of the headlights 110 and 120 are configured at a relatively narrow angle for a higher speed turn.

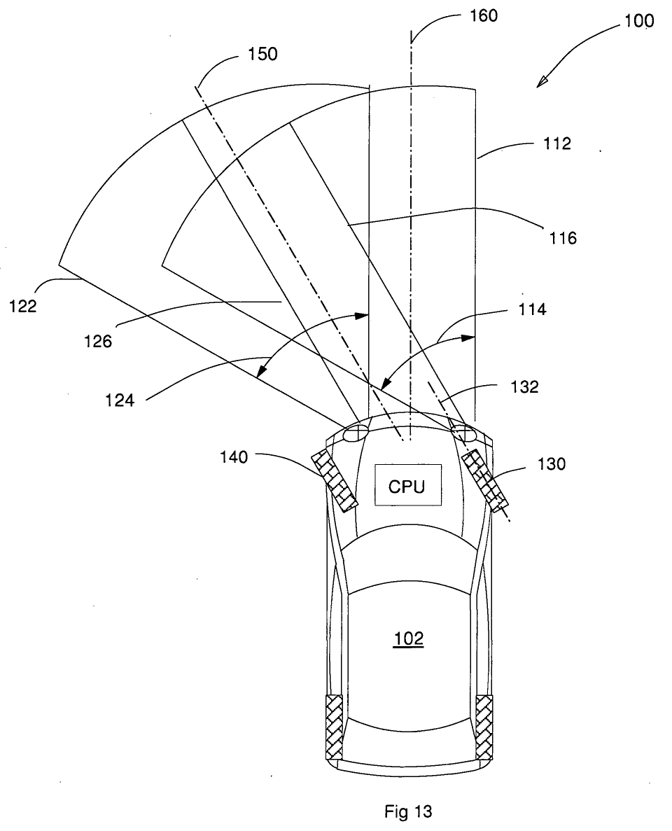

FIG. 13 illustrates a change in direction of the light beam 112 and 122 generated by the headlamps 110 and 120 to match a left turn at slower speed than the turn illustrated in FIG. 12. In this figure, the beam angles 114 and 124 are wider to match a slower speed where it may be more desirable for the driver to have a broader field of view. In this illustration the steering wheels 130 and 140 are position 132 for a sharp left turn and the direction 116 and 126 of the light beams 112 and 122 are set to match. The direction of turn 150 off of the centerline 160 of the vehicle 102

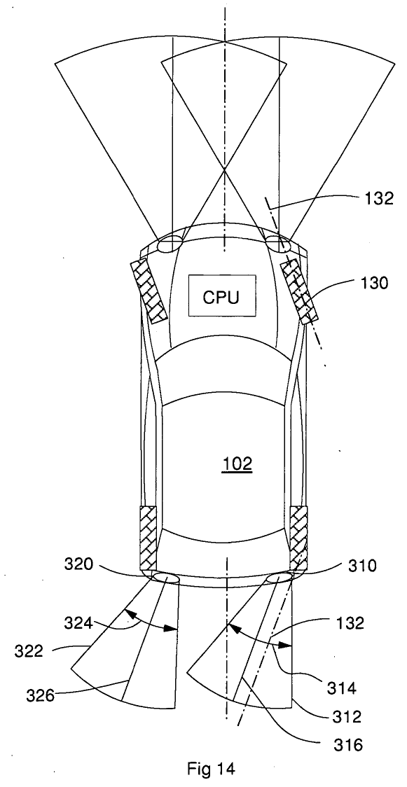

FIG. 14 illustrates a vehicle reversing with the reversing lights 310 and 320 having their light beams 312 and 322 instructed by the CPU to relate to the steering position 132 by the selection of reverse gear and so illuminate the reversing path being approximately the centre of the reversing light beams 316 and 326. Alternatively, the direction of the reversing lights 316 and 326 can be set by a lever within the vehicle. FIG. 14 illustrates a default position when the vehicle is stopped or reversing the Headlights are set to a wide beam angle and low (dipped down) direction. In alternative embodiments the may also be splayed to either opposite sides of the vehicle as well.

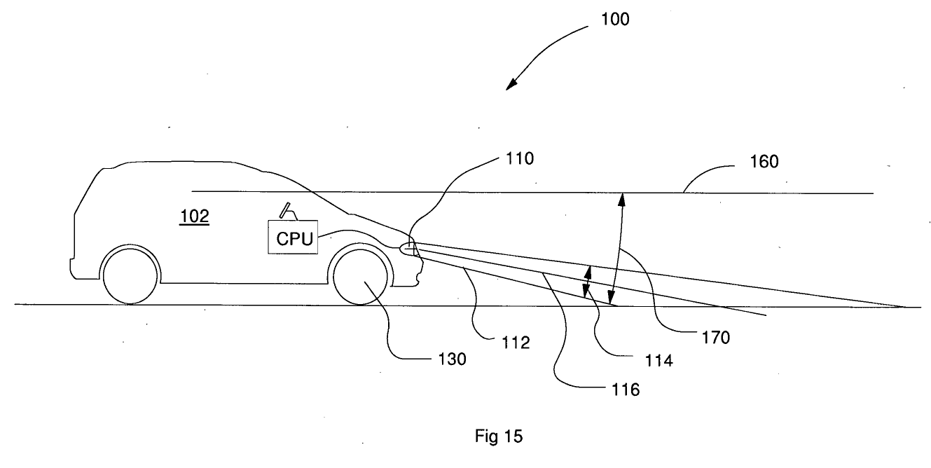

FIG. 15 illustrates a side view of the direction 116 of the light beam 112 illustrated in FIG. 10. In FIG. 15 the direction 116 of the light beam 112 intersects the ground further down the road.

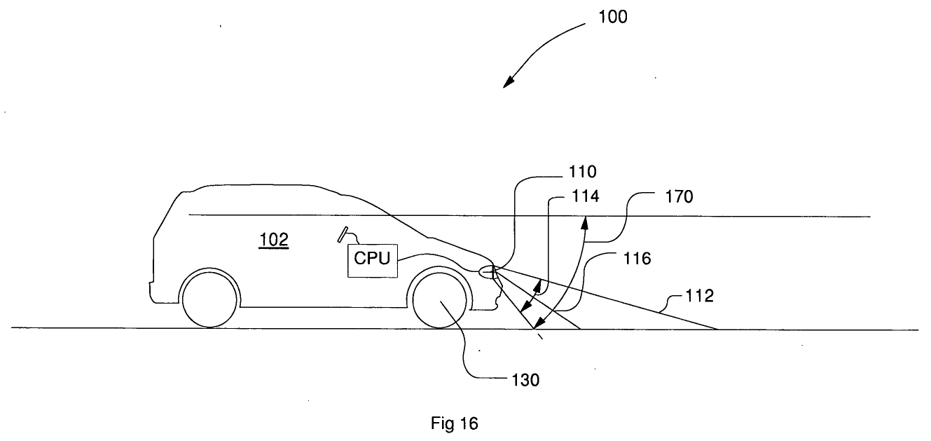

FIG. 16 illustrates a side view of the direction 116 of light beam 112 where the light beam 112 is adjusted to a wider beam angle 114 and the direction 116 of the light beam is directed closer to the front of the vehicle 102 than in FIG. 15. It will be appreciated from the detailed description of embodiments of the invention that the distance away from the vehicle of the intersection of the beam with the driving surface can be any distance between that show in FIG. 15 and that shown in FIG. 16. The angle is variable. In this embodiment, as this angle in this plane is increased, the distance from the vehicle to the intersection of the light beam and the road is decreased. It should also be appreciated that the vertical directions 116 and 126 of the light beams 112 and 122 can be coordinated or may be controlled independently. Additionally, the beam angle and direction can automatically be coordinated with driving and road conditions such as speed and steering direction or can be manually overridden by the driver.

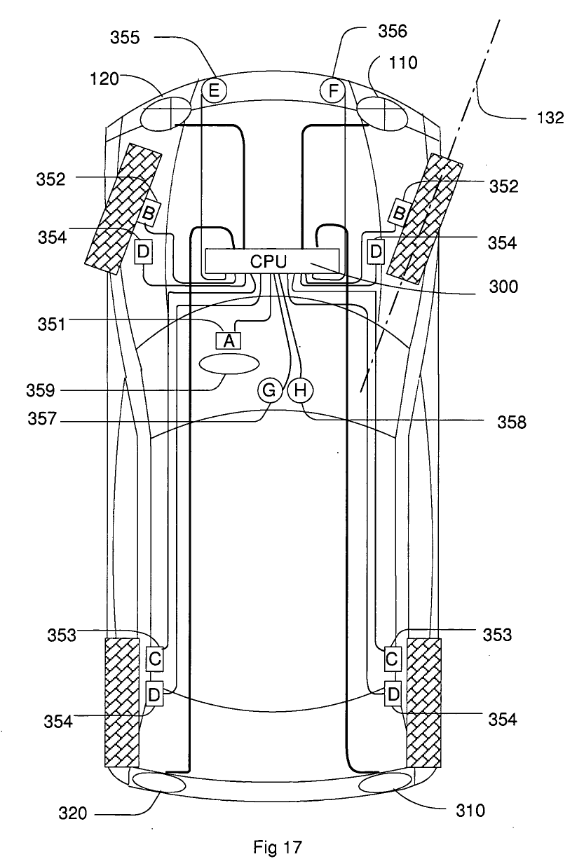

FIG. 17 illustrates the various sensors which may provide input used to control the adaptive Headlamps 110 and 120 and reversing lights 310 and 320. These sensors collect information which can be useful to automate the operation of the adaptive headlights 110 and 120, and tail lights 310 & 320 will include steering direction obtained from the steering wheel 359 via 351 sensor A and the actual angle of the steered wheels 130 from sensors B 352. The road speed of the vehicle is useful to ascertain the optimum distance from the vehicle of the Headlamp beams 110 & 120 is obtained from road speed sensors C 353. Suspension data is collected from sensors D354 located (one located at each wheel). These may be used by the vehicles CPU 300 to calculate the compensation required for the Headlamp beams 112 and 122 to stay level during acceleration when the vehicle nose tends to lift up and also under deceleration when the nose tends to duck down. Additionally when cornering at speed the vehicle will tend to yaw to the side and the collection and processing by the CPU 300 of the suspension data allows the Headlamp beams to stay level to the driving surface. The illustration also shows a sensor E 355 which monitors pertinent environmental conditions which may affect the driving conditions. Such environmental matters include rain, ice, snow and fog. A further external sensor F 356 is shown which monitors exterior lighting conditions such as streetlights. Also this light sensor could monitor an oncoming vehicle's headlamps and as they near the sensor F 356. Sensor F causes the gradual dipping down or away from the oncoming vehicle or narrowing the beam so as to not “dazzle” the oncoming vehicles driver (not shown). In prior art vehicles the user typically manually switches to low beam to avoid dazzling an oncoming vehicle. It is envisioned in this adaptive headlamp embodiment that the angle of the Head lamp beams is a dynamic and relates to many factors, particularly the speed of the vehicle but also other external factors. In the event that there is a conflict of information there can be a manual override 357 inside the vehicle which could be a type of override where several functions are available from this lever/switch arrangement. Sensor H 358 monitors when reverse gear is engaged and so brings into operation the adaptive dynamics of the rear lights. The override switch G 357 could also be linked to sensor H 358 and so arranged to operate the reversing lights so the reversing path can be illuminated independently of the steered wheels position.

In the embodiment shown CPU 300 is a general purpose microcontroller or digital signal processor such as the Freescale MAC7101 with multiple analog and digital inputs and outputs through standard input and/or output (“IO”) ports. Together these IO ports are capable of delivering the data from the sensors discussed above into a central logic and computation unit within the CPU and outputting control signals to the adaptive headlamps 110 and 120 and reversing lights 310 and 320. The microcontroller within the CPU 300 will further contain both volatile and non-volatile memory storage containing both temporary data relating to sensor inputs and control outputs as well as permanent program storage area containing the firmware software program controlling all CPU functions. In addition the non-volatile memory will contain data specific to the particular installation pertaining to parameters of movement of the adaptive headlamps 110 and 120 and reversing lights 310 and 320 such as allowable range of movement, speed of movement, timing of movement as well as the specific relationships between any and all control signals received from sensors and the required outputs to the adaptive systems.

In operation the CPU 300 receives data from all connected sensors and calculates the required output response for the adaptive systems based on this data and the instructions included in the pre-programmed firmware. One example of operation can be described as the vehicle turns a corner while traveling forward. Data from sensor 351 on the steering wheel 359 and from sensors 352 on the steered wheels 130 for angular data and from sensor 353 for road speed data will be input through the IO ports into the central logic and computation unit of CPU 300 and put into temporary storage in volatile memory. These current data values will then be evaluated and compared to desired values by the central logic and computation unit running a computer program stored in non-volatile memory. This computer program then output a resultant control signal via the IO ports to the adaptive headlamps 110 and 120 to direct them in the required direction. This process repeats continuously in a looped manner ensuring that the adaptive headlamps 110 and 120 are continuously directed in the optimum direction for the immediate conditions. The CPU 300 cycles through all the different sensors and outputs using standard prior-art polling techniques to ensure that all sensor inputs and adaptive headlamp and reversing light outputs are serviced on a regular basis, preferably not less than 10 times per second.

Additionally CPU 300 incorporates software as part of its firmware to allow prediction of future events based on current sensor input. For example the CPU 300 is programmed to take the input from the steering wheel sensor 359 and use this to predict that there will soon be a change in the position of the steered wheels thus allowing CPU 300 to swivel the adaptive headlights 110 and 120 in advance of the change in position of the steered wheels and allow the driver to get enhanced visibility into the turn he is about to make. As a further example additional sensors attached to the brake pedal provide warning to CPU 300 that the vehicle is about to undergo rapid deceleration and this data, in conjunction with suspension data from sensor 354 will allow the CPU 300 to control the tilt angle of the adaptive headlamps 110 and 120.

Now that we have reviewed some of the functionality of the adaptive lighting systems as applied to headlamps for a vehicle we turn our attention to embodiments of the lamps that allow these functionalities.

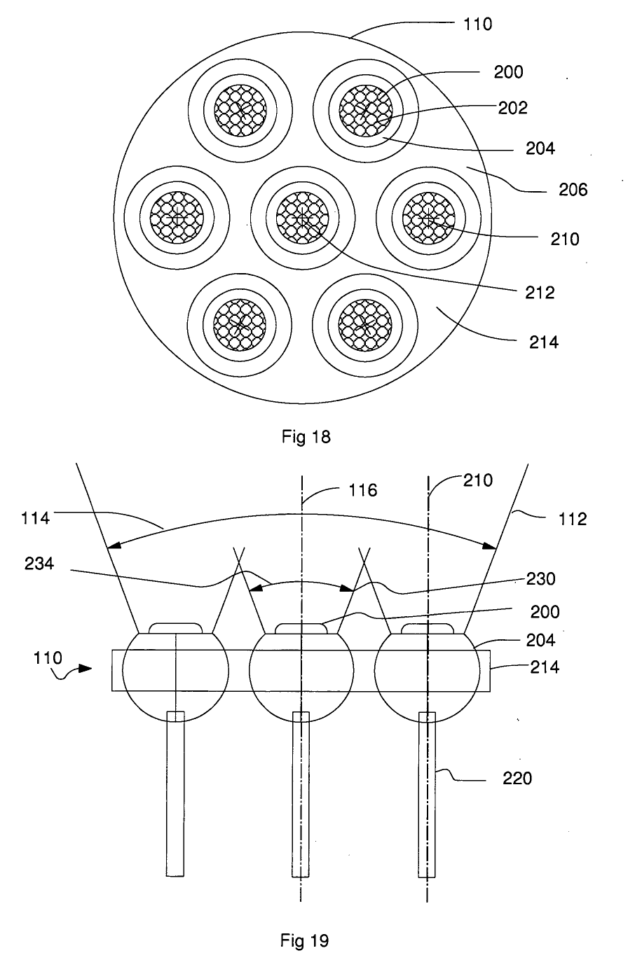

FIG. 18 illustrates one embodiment of an adaptive lamp 110. The lamp is comprised of an array 206 of lighting elements 200. Each lighting element 200 may be comprised of one lighting element or a sub array of multiple lighting elements 202. In one embodiment of these lighting elements are light emitting diodes (LED's). The lighting elements 200 are pivotably mounted 204 in relation to a base plate 214. In the embodiment shown each lighting elements 200 are comprised of subarrays of LEDs 202 which all move together when the lighting element 200 is moved relative to the base plate 214. A center axis 212 of the lighting array 206 is illustrated. Additionally a center axis 210 of one of the lighting elements 200 is also illustrated. In some embodiments the lighting elements 200 or 202 may include reflectors (not shown) or lenses (not shown) to create individual light beams. Together all of these individual light beams generate a composite light beam. By varying the orientation of the center axis 210 of the lighting elements 200, the direction and beam angle of the composite light beam can be adjusted.

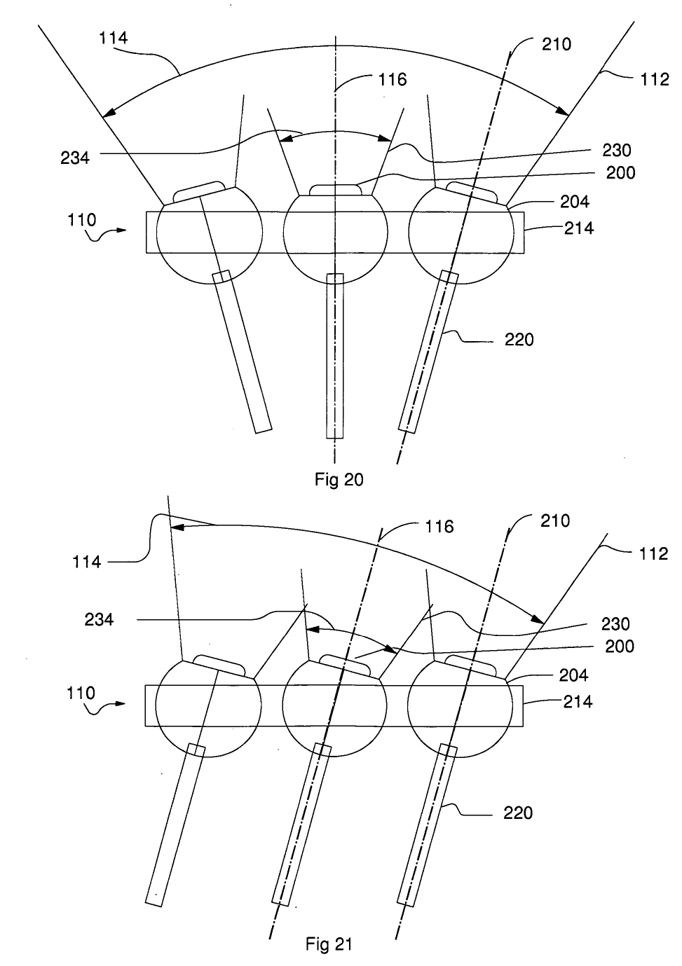

FIG. 19 illustrates a side view of light elements 200 in the lighting array illustrated in FIG. 18. In this illustration the light elements 200. The light elements generate a light beam 230 with a beam angle 234. Taken together these light beams 230 form a composite light beam 112 with a directional axis 116. The direction of the light beam is a sum of the vectoral direction of each of the direction axis of each of axises of each of the individual light elements 200. The beam angle is determined by the relative planar vectoral components of the individual axises of the lighting elements 200. In FIG. 19 the lighting elements are configured to generate a narrow beam angle 114. In FIG. 20 the lighting elements are configured to generate a wider beam angle 114. Notice that in this embodiment the beam angle 234 of the individual lighting elements remains the same.

FIG. 21 illustrates a configuration of the lighting elements 200 that changes the angular direction 116 of the composite light beam 112. This configuration allows the beam steering illustrated in FIG. 12. In FIG. 21 the composite beam remains narrow.

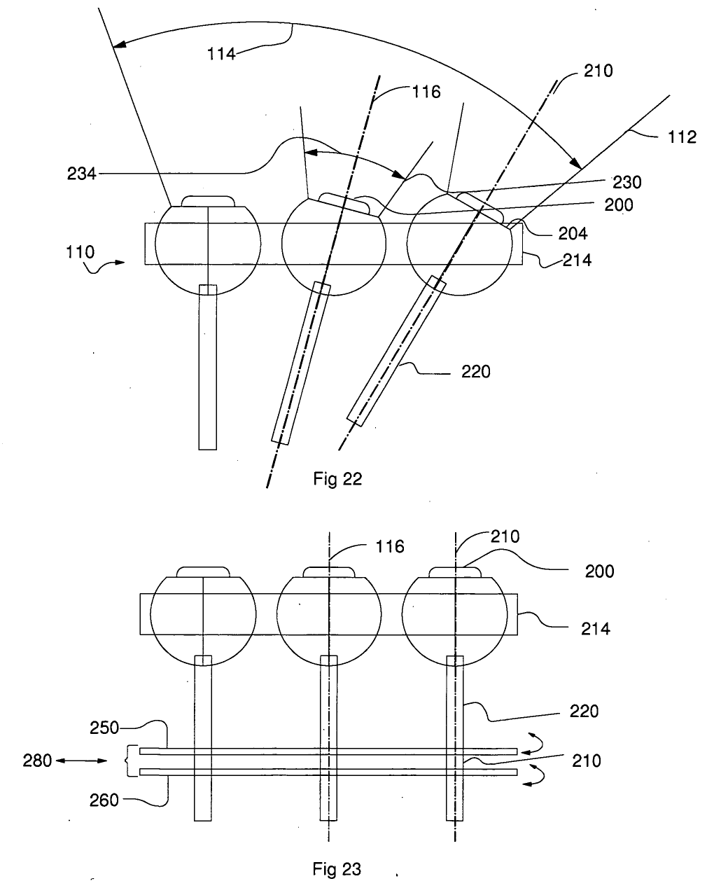

FIG. 22 illustrates a configuration of the lighting elements 200 that changes both the angular direction 116 of the composite light beam 112 and also generates a wider beam angle 114 that than that of FIG. 21. This configuration allows for the beam steering at wider beam angles illustrated in FIG. 13.

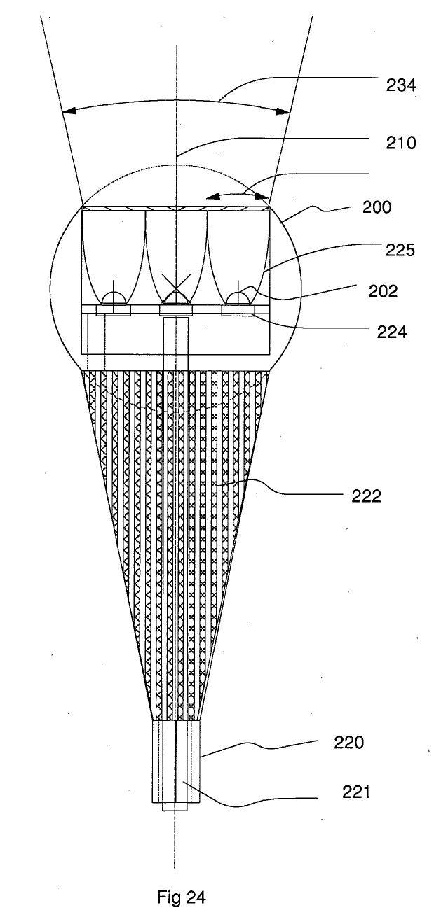

FIG. 23 illustrates one embodiment of how the center axis 210 of the lighting elements 200 can be modified to change the direction and beam angle 116 of a composite light beam 112. FIG. 23 illustrates the steering gears 250 and 260 that modify the orientation of the center axis of the individual lighting elements by moving the actuator 220. In this embodiment a lever arm is employed as the actuator for the purpose of changing the angular orientation of the lever arm relative to the center axis 116. In this embodiment the orientations are moved in unison. In other embodiments they may be moved independently. This embodiment employs the use of two complementary steering gears 250 and 260. When these steering gears are moved left or right 280 in unison in the plan of the figure, the angular direction of the composite beam as illustrated previously is modified. Shift the gears to the right and the direction of the composite beam shifts to the left. Shift the gears to the left and the direction of the composite beam shifts to the right. If the gears are shifted into or out of the page the direction of the composite beam shits out or into the page respectively. Before discussing how the steering gears adjust the beam angle of the composite beam FIG. 24 illustrates in greater detail one embodiment of one of the lighting elements 200 in lighting array 206.

FIG. 24 illustrates one embodiment of a suitable lighting element 200. This embodiment is a subarray of LED lighting elements 202 each configured with a reflector 225 that generates a light beam of a defined beam angle 236. These LEDs and reflectors are mounted to a substrate 224 which in turn is mounted to a heat sink 222 which wicks off the heat generated by the LEDs during operation. In the embodiment shown an actuation arm 220 extends from the lighting element. This actuator is engaged by the steering gears illustrated in other figures to change the orientation of the center axis 210 of the lighting element 200. In FIG. 24 a Heat Pipe 221 is shown within the heat sink 222. This can be incorporated to assist in wicking the heat away from the lighting elements 202 and substrate 224 and into the Heat sink 222.

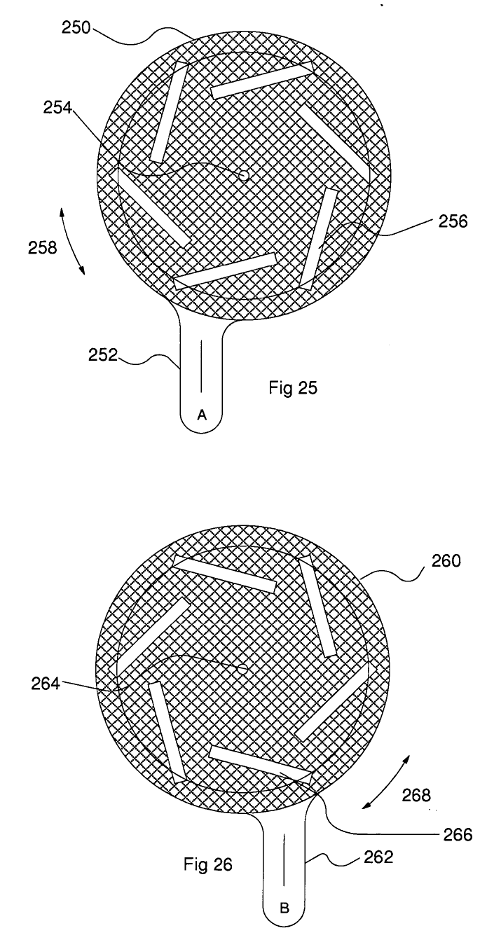

FIG. 25 and FIG. 26 are front view illustrations of embodiments of the steering gears illustrated in FIG. 23. The steering gears illustrated are designed to be complementary. Although in these illustrations both gears are designed to be rotatable 258 & 268, in another embodiment it might be more practical to have one gear remain fixed while the other is rotatable relative to the fixed gear. The steering gears 250 and 260 illustrated have actuation tabs 252 and 262 respectively. In other embodiments, a edge drives could be employed to rotate the steering gears. They also have centers of relative rotation 254 and 264. They also include slots 256 and 266 which engage the actuation arms 220 of the lighting elements and determine their position and therefore the vectoral position of the center axis of the lighting element and therefore the center axis of the light beams emanating from the light elements.

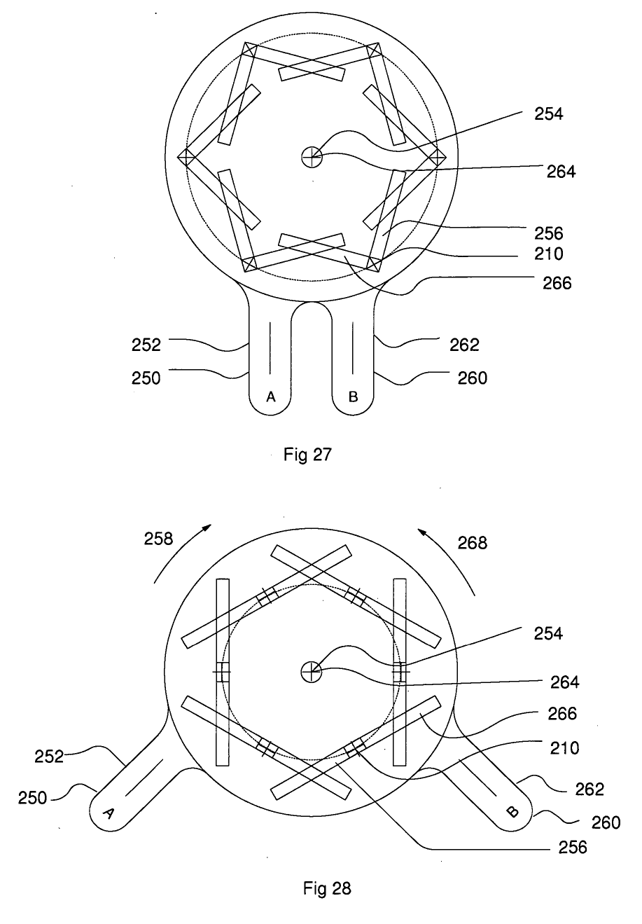

FIGS. 27 and 28 illustrate the complementary steering gears 250 and 260 as used together to steer the actuation arms of the lighting elements. The location of the center axis 210 of the actuation arms is located at an intersection of the slots 256 and 266. FIG. 27 illustrated a configuration of the steering gears 250 and 260 that generates a narrow beam angle composite light beam. FIG. 28 illustrates a configuration of the steering gears 250 and 260 that generates a wide beam angle composite light beam.

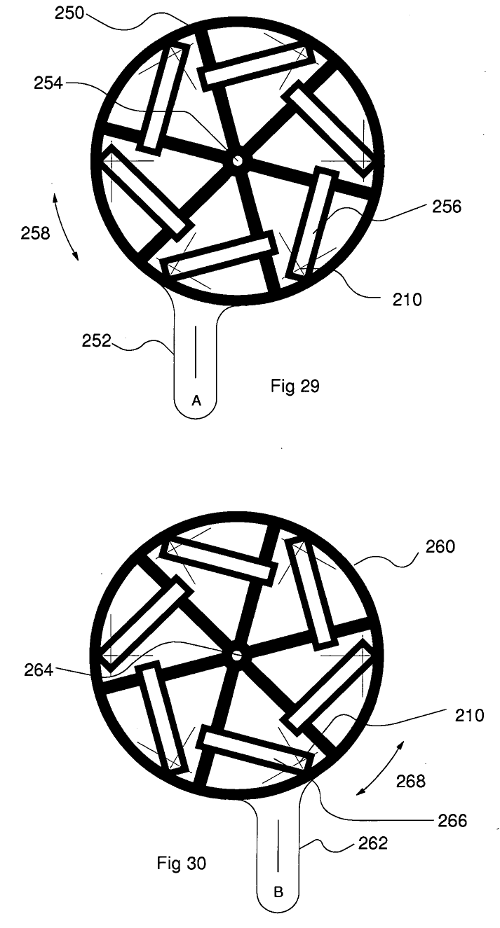

FIG. 29 and FIG. 30 illustrate alternative embodiments of steering gears where there is less material forming the cam slots within the steering gears which allows an increase in airflow to a Heat sink as shown in FIG. 24.

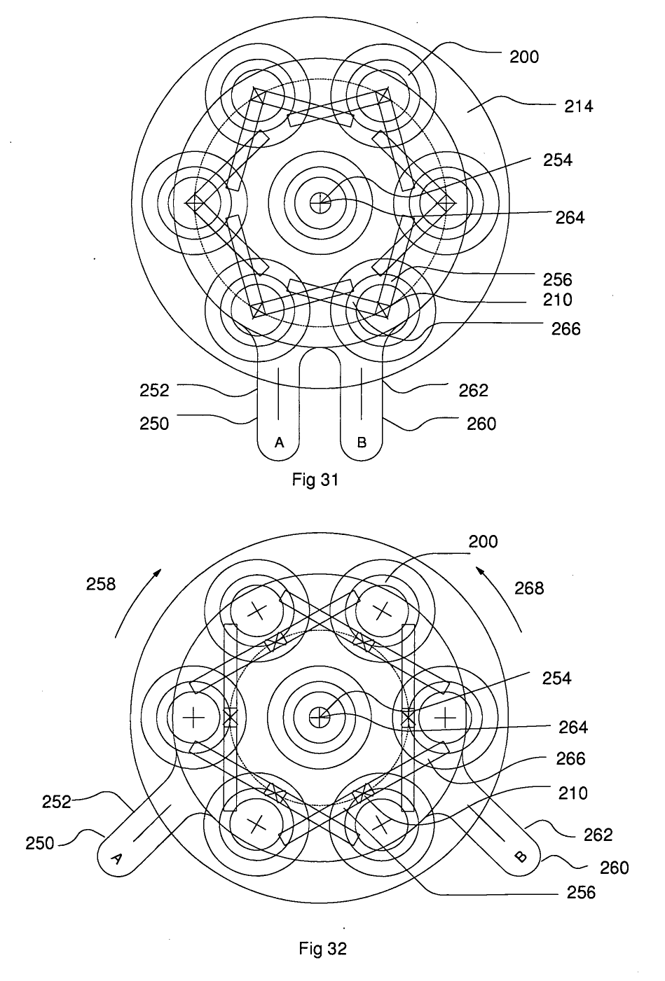

FIG. 31 and FIG. 32 illustrate how the center axises of the lighting elements in the array are shifted to generate a wide beam angle. In FIG. 31 the center axis of the light elements are all parallel so that the center axis of the lighting elements at the LED end of the axis is right on top of the center axis at the actuation arm of the lighting element, this configuration is also shown in side view in FIG. 19 and creates a narrow composite light beam. FIG. 32 illustrates how the center axis of the lighting elements at the actuation arm end of the lighting elements has been shifted toward the center axis of the lamp by the rotation in the direction shown as 258 & 268 of steering gears 250 & 260. Now the lighting elements are pointed outward creating a wider beam angle composite light beam. This configuration is shown in side view in FIG. 20.

FIG. 33 illustrates how a shift in unison of the steering gears 250 and 260 by an amount shown by 280 results in a shift of the center axis of all of the lighting elements that results in a change in direction of the center axis of the composite light beam. In the configuration illustrated the composite light beam center axis will shift in direction to the right. This configuration is shown in side view in FIG. 21.

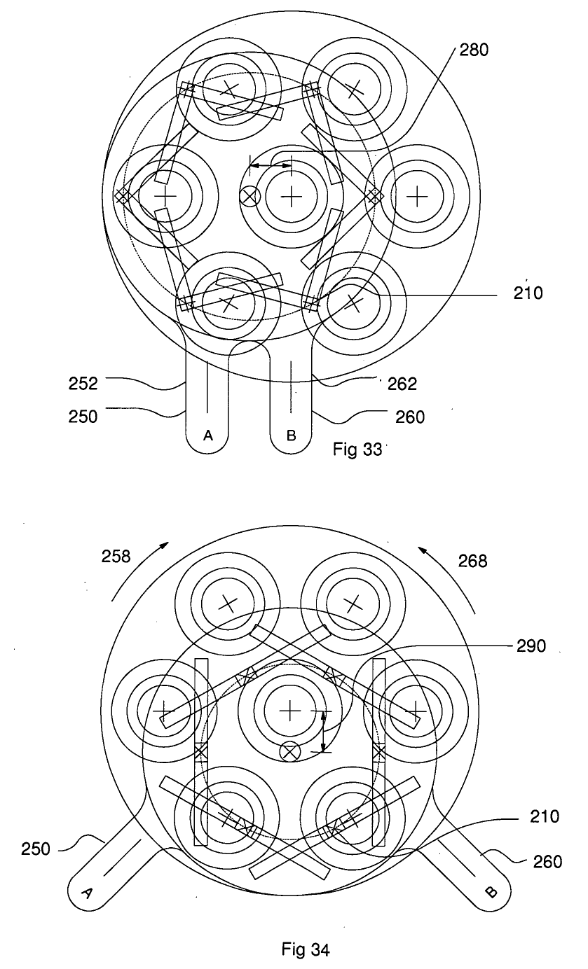

FIG. 34 illustrates a shift similar to the shift illustrated in FIG. 33 only the shift of the gears is down by an amount shown by 290 resulting in a shift in the direction of the center axis of the composite light beam up. Additionally the steering gears 250 & 260 have rotated relative to one another in the directions shown by 258 & 268 to create a wide beam.

It should be appreciated that the steering gears 250 & 260 can be moved not just in the directions indicated by 280 or 290 but in any direction relative to the base plate 214 and so any beam direction can be achieved and this directed composite light beam can be at any beam width between narrow beam shown in FIG. 33 and the wide beam shown in FIG. 34 for any beam direction.

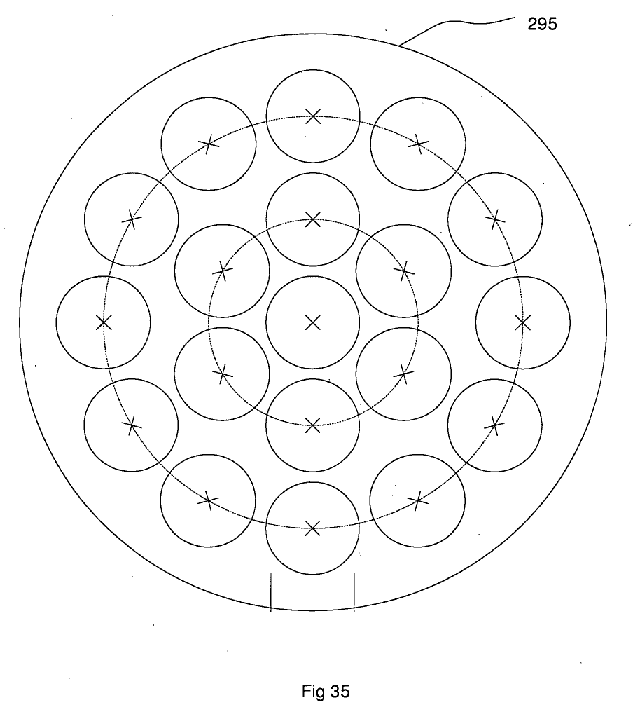

FIG. 35 illustrates an alternative embodiment of an array of light elements 200 for an adaptive lamp for a vehicle. In this embodiment the light elements are arranged on two concentric circles with a lighting element in the center.

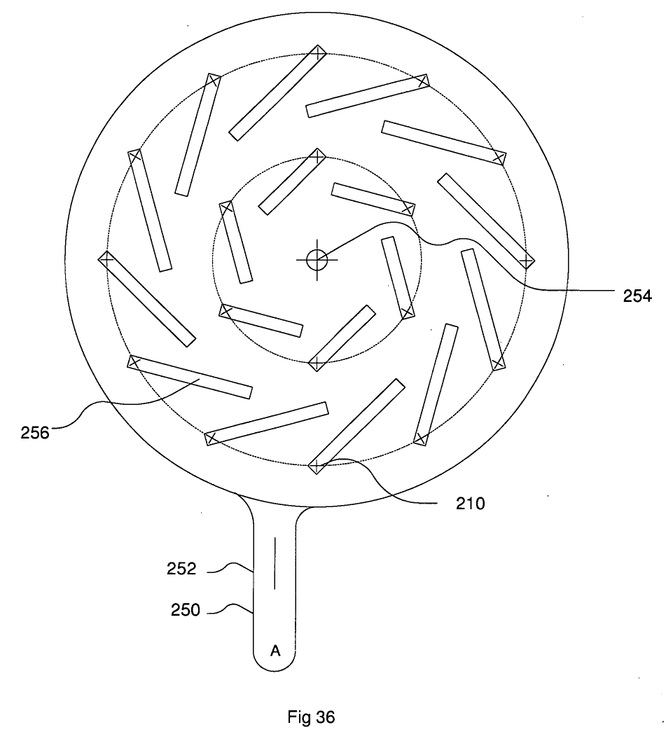

FIG. 36 illustrates one of a pair of light element steering gears 250. It should appreciated from FIG. 25 & FIG. 26 that the steering gear 260 shown in FIG. 26 is the same configuration as the other half of the pair 250 shown in FIG. 25 but flipped over and so the steering gear to FIG. 36 is not shown. FIG. 37 illustrates the steering gear illustrated in FIG. 36 combined with is complementary steering gear and the base plate 295 configured to generate a narrow beam angle light beam.

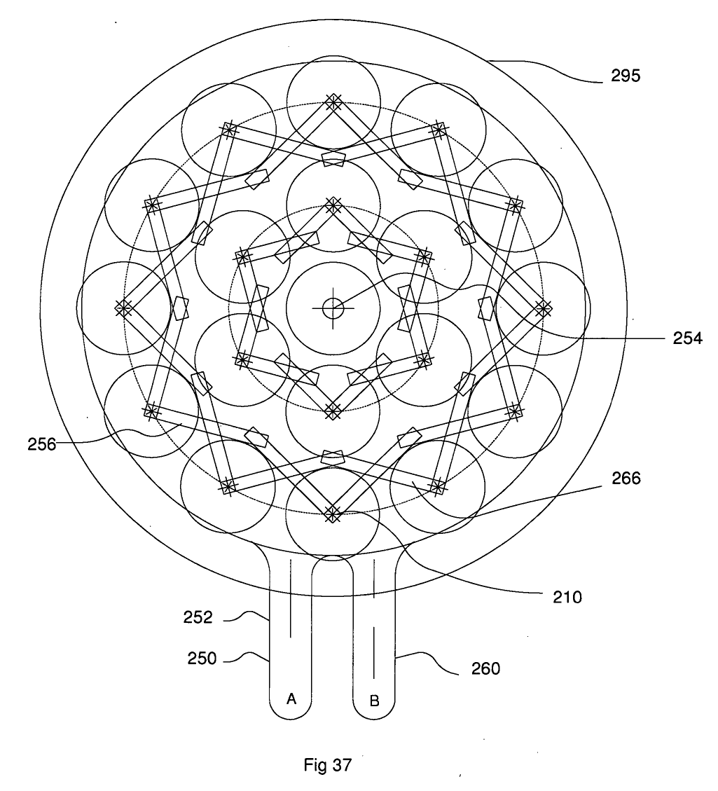

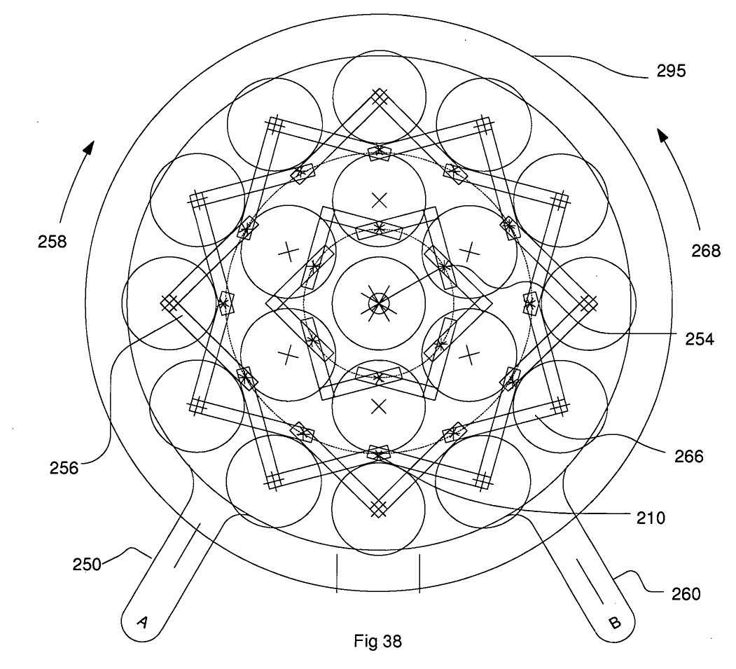

FIG. 38 illustrates the steering gears pair illustrated in FIG. 37 but configured to generate a wide beam angle composite light beam.

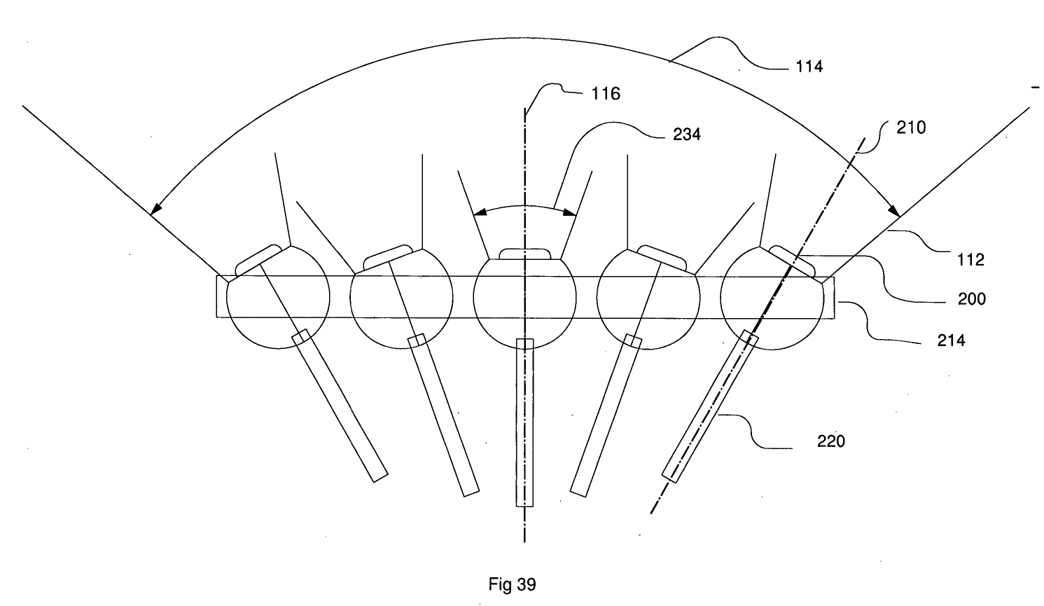

FIG. 39 illustrates a cross section of the array illustrated in FIG. 35 configured by the steering gears as illustrated in FIG. 38 to generate a wide composite beam angle 114.

It should be appreciated that the angular displacement of the lighting elements between the center light element and the outer light elements have angularly displaced less than the outer light elements. This is due to their center axis 210 having moved towards the center of the base plate 214 less then the center axis 210 of the outer light elements. It is possible to have alternative shapes, angles and configurations for the slots in the steering gears to produce any required degree of relative angular displacement. Additionally a shape such as an S shape slot would provide lesser movement at the start and end of a rotation of steering gears 250 & 260. It should be appreciated that slot shapes and angles can be arranged to cause several outcomes as desired.

Further there could be three concentric circles of the light elements. There could also be an embodiment where the outer light elements are able to create a ring of light around the main composite light beam and this ring of light could be of a differing color to the main composite beam. In alternative embodiments different color light sources may be includind in the array of lighting elements. These embodiments allow the headlights to be adaptable for different driving conditions. For example, during foggy conditions the combined light from the headlights may be given a more amber color more conducive for driving in such conditions.

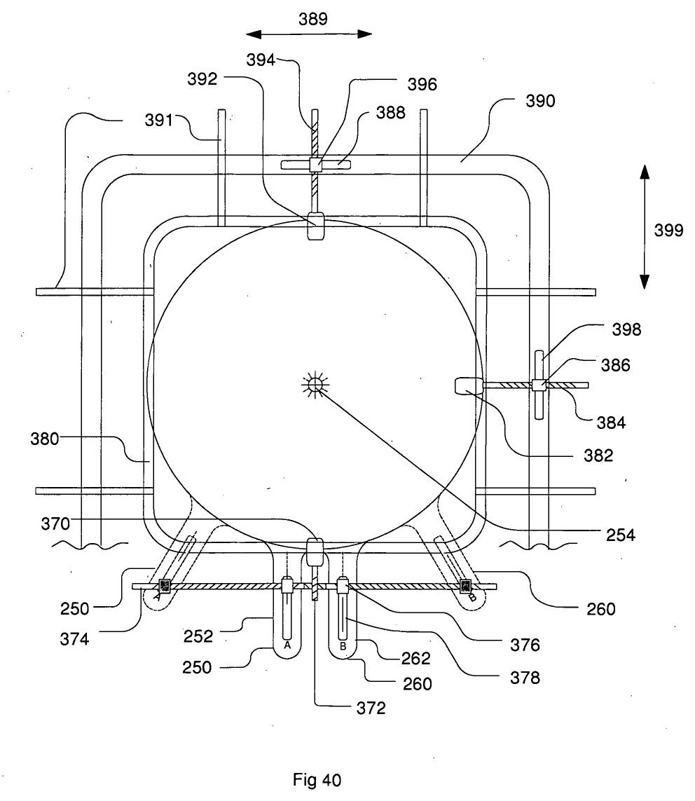

FIG. 40 illustrates a method of directing the steering gears 250 & 260 so as to direct the composite light beam. In this embodiment an electric motor 370 drives the rotation of the steering gears 250 and 260 with a worm gear shaft 372 cooperating with worm gear 374 which has a right handed thread on one side and a left handed thread on the other so that the steering gears 250 and 260 are rotated in opposite rotations when the worm gear is driven by the worm gear motor 370. The steering gears 250 and 260 have worm drive receivers 376 which travel in slots 378 situated in actuation arms 252 & 262. As the motor 370 rotates the worm drive 372 the counter opposed worm drive 374 rotates and drives the worm drive receivers outwards to form a wider composite beam in which instance the worm drive receivers slide away in their slots 378 from the centre of the unit 254 or if the motor rotates the worm drive the other direction then inwards to form a narrow composite beam. The motor 370 is attached to the carriage 380. Also attached to the carriage 380 is x axis motor 382 where its worm drive 384 cooperates with x axis worm drive receiver 386 so as to move the carriage 380 along slot 388 in the direction noted by 389 and so moves the carriage relative to the Frame 390. For clarity the bottom portion of the frame is not shown in the illustration. The frame 390 is typically in two halves with slots between the two halves and several Pins 391 fixed to the carriage 380 can slide in those slots within the Frame 390 so as the two units remains connected and the carriage 380 is free to move within the frame 390. Also attached to the carriage 380 is y axis electric motor 392 with its worm drive 394 which cooperates with y axis worm drive receiver 396 so as to move receiver 386 along the slot 398 in the y axis direction shown by 399.

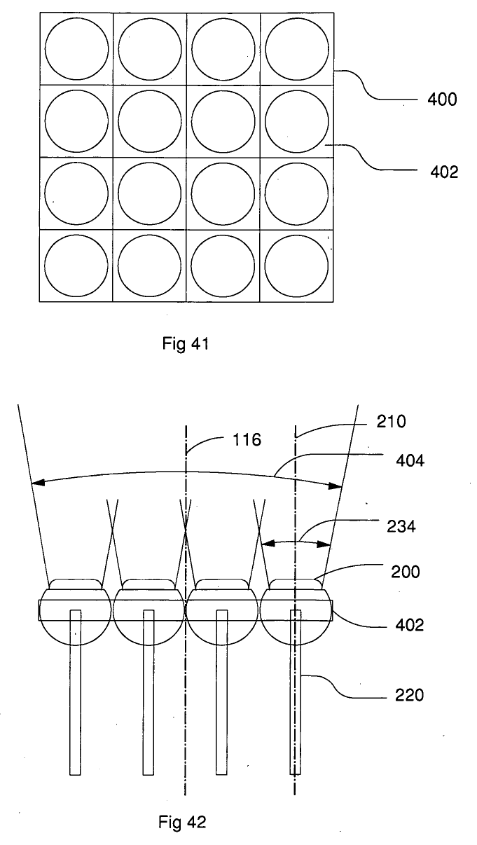

FIG. 41 illustrates an alternative embodiment of an array of light elements in a rectangular or square pattern 402 pivotably mounted on a Base plate 400. FIG. 42 illustrates a cross section of the lighting elements from the array illustrated in FIG. 41 where 404 represents the composite beam which is shown as narrow

FIG. 43 and FIG. 44 illustrate embodiments of complementary steering gears for configuring the lighting elements beam angle and direction. These steering gears will change the beam angle in the x axis but not in the y axis. The steering gear 410 will typical move in the direction 414 and steering gear 420 will typically move in direction 424, both movements considered to be the y axis.

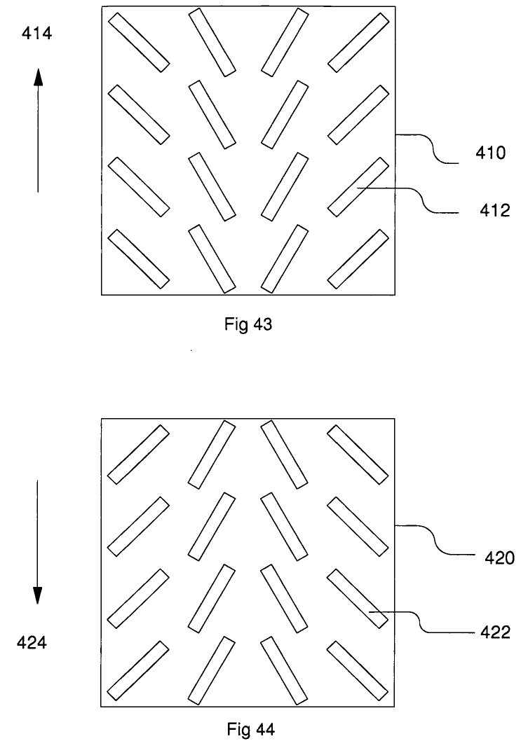

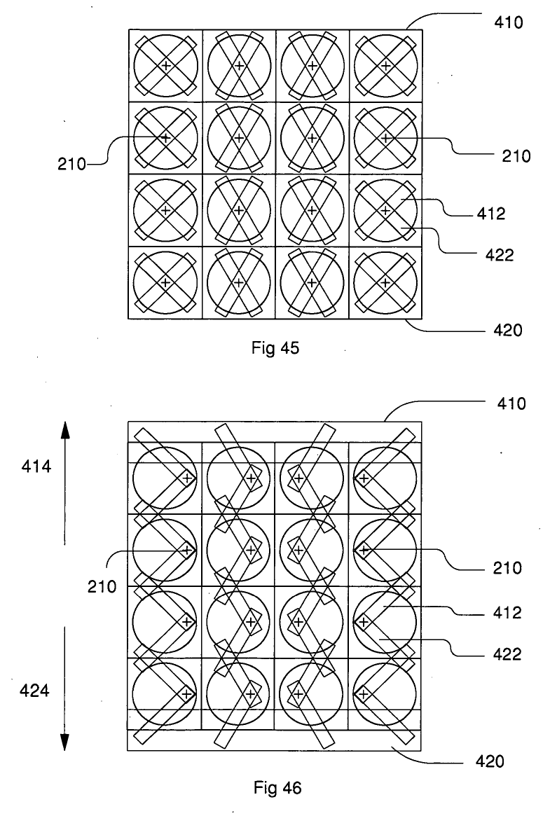

FIG. 45 shows the steering gears configured to generate a narrow beam angle. In FIG. 46 the steering gears have been moved relative to each other along the y axis with the steering gear shown in 410 moving up in the direction 414 and the steering gear 420 moving down the page in the direction 424. The outcome is points 210 have moved together along the x axis and so a wide beam in the x axis, but not the y axis has been created.

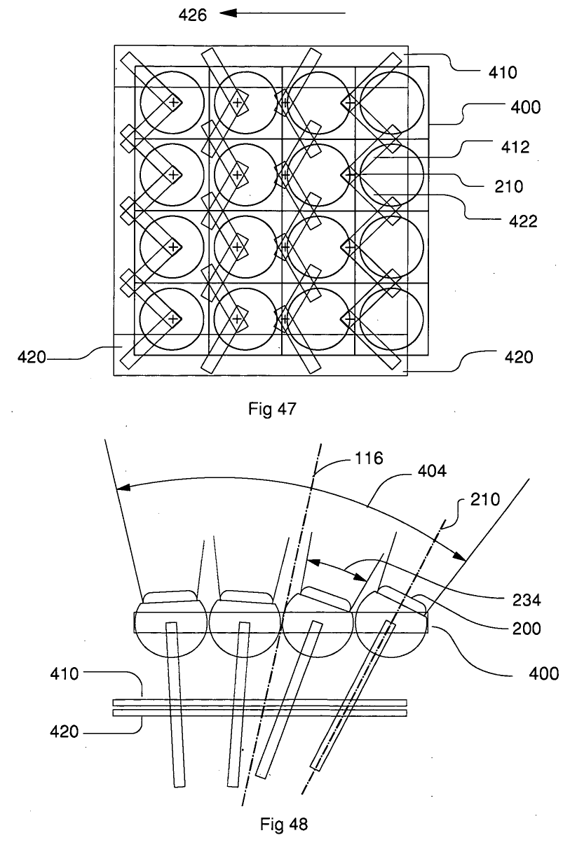

FIG. 47 and FIG. 48 illustrate the position of the steering gears and the light elements respectively in a wide composite beam angle 404 configuration as formed by FIG. 46 and where the steering gears have been moved in unison in the x axis noted by 426 causing 210 to move to the left and so the composite wide beam has been steered to the right. It would be perfectly possible to move the steering gears down the page in line with y axis so steering the composite beam up the page or have any combination of moving the steering gears along both x axis and y axis.

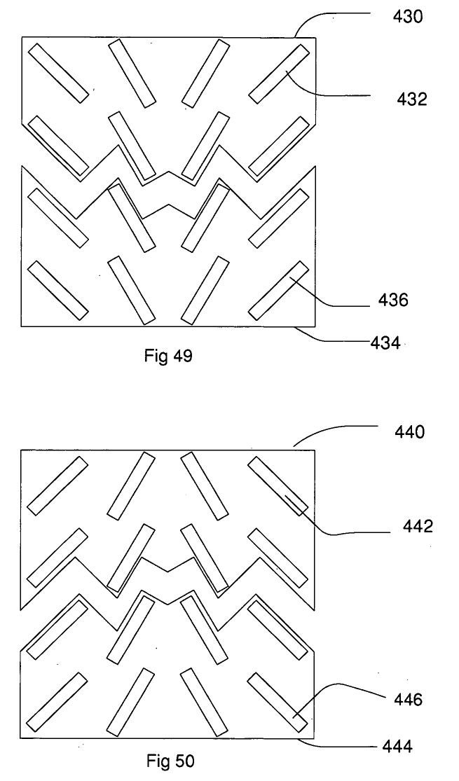

FIG. 49 and FIG. 50 illustrate a different embodiment of steering gear for a square or rectangular array of lighting elements. With this embodiment the slots in the gears are configured so that they configure the light elements to simultaneously adjust the beam angle in both the x axis and y axis so that the overall beam angle is adjusted rather than the beam angle along only the x or y axis. In FIG. 49 the steering gear is in two parts 430 & 434 which can be moved together so as to move slots 432 & 436 together. This would cause the light elements to angularly displace in the y axis. FIG. 50 is a similar configuration being a flipped illustration of FIG. 49 also in two parts 440 & 444 and moving the two halves together would cause slots 442 & 446 to move towards each other.

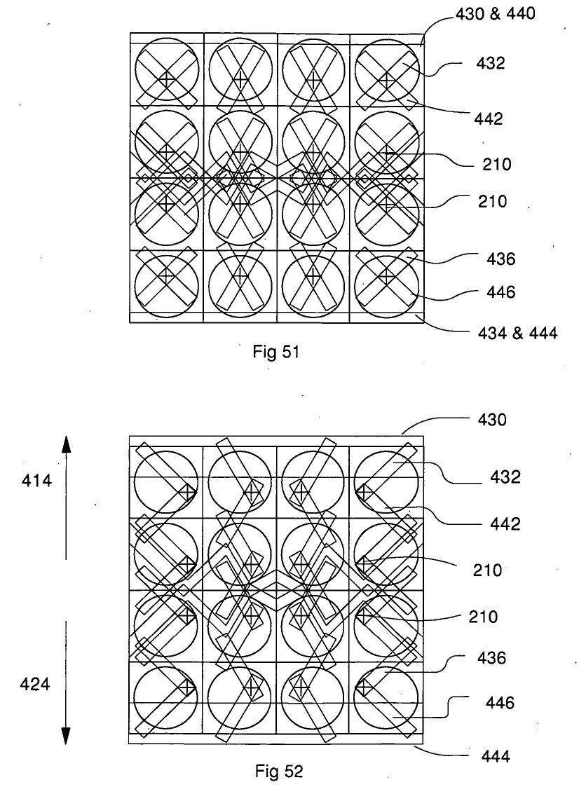

FIG. 51 illustrates the two parts of the steering gear 430 & 434 pushed together in comparison to the distance apart shown in FIG. 49 and the two halves of the steering gears 440 & 444 have been pushed together an equal amount. The outcome as shown in FIG. 51 is that there has been a widening of the composite beam in the y axis. This because slots 432 and 442 in combination have moved closer to the combination of slots 436 and 446. Consequentially points 210 have moved closer together along the y axis. No widening of the composite beam in the x axis has occurred as yet. FIG. 52 shows that a widening in the x axis can be added to the widening in the y axis in FIG. 51 by moving steering gears 430 & 434 in the direction 414 as in FIG. 46 and moving steering gears 440 & 444 in the direction 424 as in FIG. 46. This adds a widening of the composite beam in the x axis as per FIG. 46 whilst retaining the widening in the y axis achieved in FIG. 51.

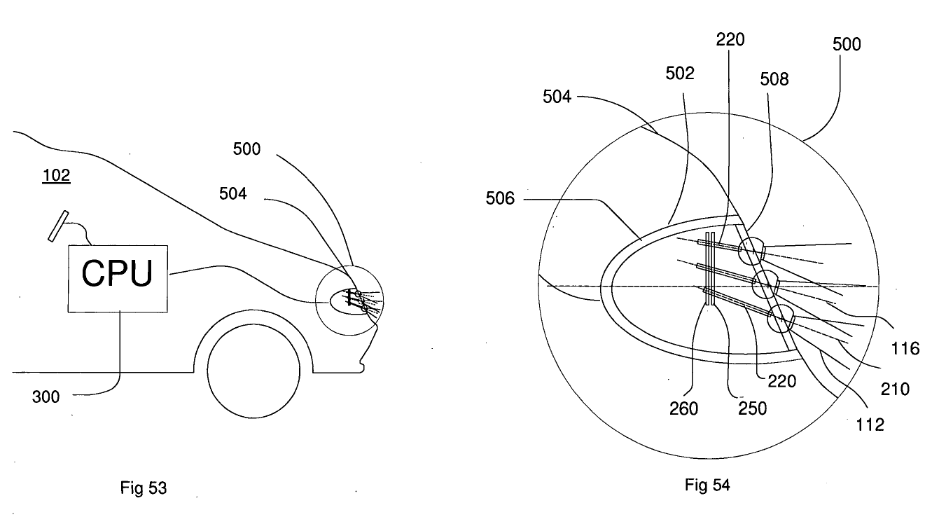

FIG. 53 and FIG. 54 illustrate an embodiment of adaptive system headlights 500 where the skin or outer chassis 504 of the vehicle 102 provides the function of the base plate (214 in previous figures). FIG. 53 and FIG. 54 actually illustrate an adaptive headlight system where the base plate 508 is aligned with the geometry of the outer surface of the skin or outer chassis 504 of the vehicle 102.

FIG. 54 illustrates the headlights 500 in one such embodiment in greater detail. FIG. 54 illustrates how a portion 508 of the skin 504 of the vehicle supports the lighting elements 220. or could be aligned with the geometry of the outer surface or the skin or outer chassis 504 of the vehicle 102. this portion 508 may be made of the same material as the rest of the chassis or could be manufactured of other metals plastic, glass or other materials. FIG. 54 also illustrates the position of the steering gears 250 and 260 which in the embodiment shown are housed in a protective casing 506. FIG. 54 also illustrates how the actuator arms 220 can be different lengths and engage the steering gears 250 260 at different points.

It should be appreciated that now it has been shown that a square or rectangular configuration can be widened in both the x and the y axis and that a circular configuration as shown in FIG. 38 also widens in both the x and the y axis that many other arrays of the lighting elements are also possible and are contemplated. For example, in many applications an oval configuration would be desirable or even preferable. Additionally it is not necessary that the lighting elements have articulation arms. In alternative embodiments the LED's could be surface mounted on a circuit board that changes the pivotal position of the light element in the array by electronic actuators such as the actuators used for tilting mirrors on a digital mirror projector device. In an alternative embodiment each acuautor could be moved by an electric motor, or other electronic or pneumatic drive thus dispensing with the need for steering gears.

It should be appreciated that in the preferred embodiment the adaptive lighting system 100 can gradually adjust the beam angle adjustment from a narrow angle illustrated in FIG. 10 to a wide angle illustrated in FIG. 11. It should also be appreciated that the adaptive lighting system 100 can be speed sensitive so that it can be set to automatically adjust the beam angle in consideration of the rate of travel of the vehicle. In one embodiment of the invention the lighting system receives instructions from a CPU in the vehicle. The vehicle CPU may provide information that can be processed by the CPU to adapt the output of the headlamps to the driving conditions. For example the CPU might take input from the speedometer to gradually narrow the light beam and change the direction of the light beam further in front of the vehcile. The CPU might also take information concerning the position of the front wheels and the speed of the vehicle to adjust the direction of the light beams. Since the light beams are CPU controlled each lamp may be controlled individually. The degree of the change of the direction of the composite light beam can be a function of the speed of the vehicle and the angle of change of the wheels and therefore the direction of travel.

The vertical direction of the beam may also be adjusted to compensate for upward lift of the front of the vehicle during rapid acceleration and downward movement of the front of the vehcile during front wheel braking. The vertical direction of the beam may also be adjusted for roll of a vehicle during turning or in reaction to information feed to the CPU form positional sensors or accelerometers sensing the movement of the vehicle over rough terrain.

In a preferred embodiment the beam is widened for slower rates of travel and narrowed for faster rates of travel. In the preferred embodiment the driver is also provided with an override to set the desired beam angle or to set the adaptive headlight to adjust its configuration for other driving conditions such as fog or precipitation such as rain, snow or sleet.

The adaptive headlights can also be configured to be retrofit into prior art head lights or tail lights. Existing vehicles typically have cavities in their chassis into which conventional lights are received/housed. Typically the chassis serves to protect the conventional light fixtures. Retrofited adaptive fixtures would fit into these cavities. Some embodiments of retrofit adaptive fixtures fixture would extend out further than the conventional bulb which is typically recessed from the geometic line of the chassis for protection. With conventional lamps the light emitting source is recessed in a reflector thus limiting the ability of the beam to illuminate in the direction of forward travel while coming or turning.

As previously stated, the Base Plate 508 can be aligned with 504 means that the material the Base Plate can be composed of could be glass, as is the case with conventional vehicular lights, so as to preserve the aesthetic design of the vehicle manufacturer. Such an Adaptive Light unit could be retrofitted to the majority of existing vehicle designs so the change to adaptive lighting does not require any redesign of the vehicle exterior. Alternatively the Base Plate 508 could be of the same material, typically metal, as the surface of the vehicle 504. If it is the same material as the surface it can be the same color and blend into the skin. As the Base Plate can be of the same material as the surface of the vehicle it is also possible to dispense with the need for a distinct Base Plate entirely. The Base surface with which the light elements cooperate could be a continuation of the vehicle surface and in this instance there would be no requirement for a front hole to the cavity 502. This will allow new designs for vehicle designers and manufacturers. Both the retrofit embodiment and the embodiment where the Base Plate is the surface of the vehicle apply to both front and rear vehicular lighting.

In some embodiments of a retrofit system, the headlamp includes a microcontroller (not shown) which converts high beam and low beam information into steering gear instructions to configure the lighting elements to obtain the desired results of light intensity and beam angle. In more complicated retrofit embodiments it is necessary to replace the vehicles CPU and/or software/firmware and provide additional control signals to the retrofit headlights so that the adaptive headlights can be adapted to other driving parameters such as the speed and direction of travel.

Accordingly, it is to be understood that the embodiments of the invention herein described are merely illustrative of the application of the principles of the invention. References made herein to details of the illustrated embodiments are not intended to limit the scope of the claims, which themselves recite those features regarded as essential to the invention.

We claim:

1. A vehicular light emitting device comprising:
a light emitting source in which at least one parameters can be incrementally adjusted over a predetermined range; and
an automated controller that receives information concerning travel conditions in response to which it adjusts the incrementally adjustable parameter.

2. The vehicular light system of claim 1 where the direction of the beam is steerable to the left and right in a substantially horizontal direction and is controlled by the steering of the vehicle.

3. The vehicular light system of claim 1 where the speed of the direction change left and right of the beams is controlled by the speed of the that steering change.

4. The vehicular light system of claim 1 where the speed of the direction change left and right of the beams is controlled by both the steering and the speed of the that steering wheel turn.

5. The vehicular light system of claim 1 where the direction of the beam is directly related to the steering.

6. The vehicular light system of claim 1 where the direction of the beam is indirectly related to the steering so the steering turns the beams to a greater or lesser extent than the steering turn would directly cause.

7. The vehicular light system of claim 1 where the direction of the beam is indirectly related to the steering so the steering turns the beams quicker or slower than the steering turn would directly cause.

8. The vehicular light system of claim 1 where the direction of the beam is indirectly related to the steering so the steering turns the beams earlier or later than the steering turn would directly cause.

9. The vehicular light system of claim 1 where the direction of the beam is indirectly related to the steering so as to effect a quicker and/or earlier and greater beam movement when steering into a corner and a slower and/or later beam movement when straightening the steering back out of the corner.

10. The vehicular light system of claim 1 where the distance of the direction change left and right of the beam is controlled by both the steering and the speed of the vehicle.

11. The vehicular light system of claim 1 where the height of the beam is controlled by the speed of the vehicle.

12. The vehicular light system of claim 1 where the width of the beam is controlled by the speed of the vehicle.

13. The vehicular light system of claim 1 where the distance of the beam from the vehicle to the driving surface is controlled by the speed of the vehicle

14. The vehicular light system of claim 1 where the size of the beam is controlled by the speed of the vehicle.

15. The vehicular light system of claim 1 where at slow speed the beam of light formed by the plurality of LEDs is near the vehicle and has a wide beam.

16. The vehicular light system of claim 1 where at a faster speed the beam of light formed by the plurality of LEDs is further away from the vehicle and has a narrower beam.

17. The vehicular light system of claim 1 where in fast cornering the light beams compensate for the yaw or tilt of the car axis away from the radius of the corner whilst steering the beams so the LED ALS raises or lowers the beam heights independently from each other so as to maintain an even coverage of the light beams on the driving surface.

18. The vehicular light system of claim 1 where the LED array support member can rotate in a socket to compensate for the vehicle tilting whilst driving over rough terrain and so maintain an even light coverage on the driving surface.

19. The vehicular light system of claim 1 where under acceleration the light beam compensates for the typical upward lift of the front of the vehicle by adjusting downwards and so is at the chosen distance from the vehicle for its speed at any given moment.

20. The vehicular light system of claim 1 where under deceleration/braking the light beam compensates for the typical downwards motion of the front of the vehicle by adjusting upwards and so is at the chosen distance from the vehicle for its speed at any given moment.

21. The vehicular light system of claim 1 where the light beam compensates for any rocking motion of the front of the vehicle by way of the suspension or shock absorbers and so is at the chosen distance from the vehicle for its speed at any given moment.

22. The vehicular light system of claim 1 where when the vehicle is driving on an incline the light beam adjusts to compensate for the angle of the vehicle and so is at the chosen distance from the vehicle for its speed at any given moment.

23. The vehicular light system of claim 1 where the direction of the beam is related to the steering via a Control Processor Unit (CPU) so the steering moves the beam more or less than a direct connection to the steering allows, to effect a greater or lesser beam movement into corner and out of the corner.

24. The vehicular light system of claim 1 where the direction of the beams is related to the steering via a Control Processor Unit (CPU) so the steering moves the beams more or less than a direct connection to the steering allows and the time taken to effect these movements is related to the speed of the vehicle.

25. The vehicular light system of claim 1 where the direction of the beams is related to the steering via a Control Processor Unit (CPU) so the steering moves the beams more or less than a direct connection to the steering allows to effect a greater beam movement when cornering and the start of the beam movement is earlier into the corner and the return time earlier coming out of the corner than that created by direct steering and the timing of these movements is related to the speed of the vehicle.

26. The vehicular light system of claim 1 where a CPU polls data from the vehicle, such as suspension data, yaw data, vehicle speed data, steering angle position data and uses that data to control the aspects of the LED ALS such as self levelling of the beams, beam width and its distance from the vehicle and the angle of the beams relative to the vehicle.

27. The vehicular light system of claim 1 where the light is a vehicular headlight.

28. The vehicular light system of claim 1 where the light is a vehicular rear light.

29. The vehicular light system of claim 1 where the light is a vehicular reversing light.

30. The vehicular light system of claim 1 directed to the rear of a vehicle and lamps are located at the rear of a vehicle and is responsive to the selection of reverse gear and the direction of the beam is inversely related to the steering of the vehicle.

31. The vehicular light system of claim 1 which is retrofitable into a conventional vehicular light socket.

32. A vehicular light emitting system comprising:
a plurality of light emitting elements which each individually create a directed light beam with a beam direction and together form a composite directed light beam with a beam shape and beam direction;
articulatable pivots on a plurality of the lighting elements whereby the direction of an individual light beam can be adjusted; and
a pivot articulation control whereby the articulation of the plurality of articulatable pivots are coordinated adjust the shape and/or direction of the composite light beam.

33. The vehicular light system of claim 32 where should a fault arise, the system fails safe by angling the light beam downwards over a predetermined time so as to avoid dazzling any other traffic.

34. The vehicular light system of claim 32 where should a fault arise the system fails safe by angling down over a predetermined time so as to avoid dazzling any other traffic and if the vehicle is in motion it is brought to a halt over a predetermined time.

35. The vehicular light system of claim 32 where should a fault arise the system fails safe by angling down over a predetermined time so as to avoid dazzling any other traffic and that fault is detected by sensors and another light source is switched on to compensate for the main system failure.

36. The vehicular light system of claim 32 where there are sensors on the vehicle able to determine the weather conditions and adapt the Headlight(s) according to those conditions and where that adaptation includes the dimming up and down of the formed light beam.

37. The vehicular light system of claim 32 where there are sensors on the front of the vehicle able to determine the Headlights from an oncoming vehicle and its distance and to gradually adjust the light beam to avoid dazzling the oncoming vehicle and so avoid the typical bump switch from full beam to dipped beam.

38. The vehicular light system of claim 32 where the colour of the light beam can be varied.

39. The vehicular light system of claim 38 where the colour of the light beam can be varied dependant on speed and/or weather conditions.

40. The vehicular light system of claim 38 where sensors detect the ambient street light level in a driving environment such as a city and adjusts the colour of the light accordingly.

41. The vehicular light system of claim 32 where the LEDs are arranged on an array in, or substantially in, a circular configuration.

42. The vehicular light system of claim 32 where the LEDs are arranged on an array in, or substantially in, an oval configuration.

43. The vehicular light system of claim 32 where the LEDs are arranged on an array in, or substantially in, a rectangular configuration.

44. The vehicular light system of claim 32 where the Adaptive movement of the beam is caused by motors typically being stepper motors or micro stepper motor, or servo motors.

45. The vehicular light system of claim 32 where the Adaptive movement of the beam is caused by motors driving the angular deflection of the LEDs or LED arrays via worm drives or gears.

46. The vehicular light system of claim 32 where the Adaptive movement of the beam is caused by motors driving the angular deflection of the LEDs or LED arrays via gears and there is no elongate element required to effect the angular displacement with the motors acting directly on the joint to the support member.

47. The vehicular light system of claim 32 where the Adaptive movement of the beam is caused by motors controlling a plate or plates (or Former, or Formers) which cooperate with the LED arrays and where the movement of the plate or plates causes the angular deflection of the LEDs, or arrays or LEDs, relative to the support, so changing the beam characteristics.

48. The vehicular light system of claim 32 where there is adjustment available to a pair of Headlights so their relative angles to the vehicle and to each other can be changed so as when the vehicle is to be driven on the other side of the road an adjustment can be effected to for a particular export market depending on what side of the road the vehicle will travel.

49. The vehicular light system of claim 32 where the change to the relative angles can be actuated manually by a switch.

50. The vehicular light system of claim 32 where the change to the relative angles can be actuated automatically by a CPU.

51. The vehicular light system of claim 32 where there are elongate elements attached to the LEDs or LED arrays and those elongate elements function as heat sinks.

52. The vehicular light system of claim 32 where there are elongate elements attached to the LEDs and those elongate elements are Heat pipes which dissipate heat generated from the LEDs or LED arrays.

53. The vehicular light system of claim 32 where any necessary cooling required by the LEDs or LED arrays is by liquid cooling that forms part of the vehicle's cooling system.

54. The vehicular light system of claim 32 where the lighting elements extend out from the geometric line of the vehicle in which they are installed.
